(19) United States
(12) Patent Application Publication
(10) Pub. No.: US 2003/0055767 A1
(43) Pub. Date: Mar. 20, 2003

(54) Insurance contract method, insurance contract system, portable terminal and insurance contract computer program product

(75) Inventors: Ryo Tamura, Tokyo (JP); Chikara Takauji, Tokyo (JP); Shigeru Saiki, Tokyo (JP); Yoshifumi Kikumoto, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/244,076

(22) Filed: Sep. 16, 2002

(30) Foreign Application Priority Data
Sep. 18, 2001 (JP) 2001-282840
Dec. 6, 2001 (JP) 2001-373351

(51) Int. Cl. G06F 17/60

(52) U.S. Cl. 705/36

(57) ABSTRACT

It enables users to surely and easily manage the subscribed insurance in an insurance contract system which achieves a new contract, change and the like of the contract content through a portable terminal. An agency server generates a software component comprising a user profile of a user, insurance commodity information suitable for the user, a control program and a storage, and installs it to a portable terminal. The user starts the control program in the software component of the portable terminal to generate the contract content of the insurance for the new contract, contract change and the like based on information about the selected insurance commodity, inputted data of the premium and the like, the user profile, a policy number generated by the control program and the content of the storage, and then transmits it to the insurance server through a network. The insurance server, upon receiving the contract content normally, returns ACK. The portable terminal stores the ACK and the transmitted contract content to the storage by corresponding them to one another.

### BACKGROUND OF THE INVENTION

1. Field of the Invention

The present invention relates to insurance contract methods and insurance contract systems, more specifically, to a method and a system in which subscription for insurance, renewal or change of the subscribed insurance content can be achieved through portable terminals.

2. Description of the Related Art

There are various kinds of insurance such as life insurance, transportation insurance, fire insurance, and fiduciary insurance. In the past, in order to newly subscribe for such insurance, or renew or change the contract content of the subscribed insurance, it was necessary every time to go through procedures for subscription or change through an insurance agency or an insurance sales person. Thus, it was not a simple procedure to subscribe for insurance or to change the insurance content. Therefore, there has been a strong demand for a system by which subscription for insurance and change of contract content can be easily achieved.

Japanese Patent Application laid-open 2000-298686 (in the followings, referred to as Document 1) discloses an example of techniques which can easily achieve insurance contract such as new subscription for insurance. The related art disclosed in the Document 1 makes it possible to achieve new subscription for insurance, renewal and change of the contract content in the manner as described in the followings.

First, an exclusive terminal called an insurance terminal device is placed in a convenient position such as at a convenience store (kind of a drag store or a grocery store). The exclusive terminal is connected so as to be able to communicate with a central processing apparatus in a center through a communication circuit. Users achieve the subscription procedure for insurance through the exclusive terminal. Information of insurance commodity widely used for unspecific number of people and a program for controlling procedures for insurance contract based on the information are installed in the exclusive terminal. At the time of new subscription for insurance, the exclusive terminal receives data regarding an insurance contractor himself/herself (address, name, age and the like) and data showing the insurance contract (types of insurance commodity, premium and the like), and temporarily stores the data inside while transmitting them to the center. The central processing unit in the center, upon receiving the data, generates policy number and stores the received data with the policy number in the storage by corresponding them to one another. Also, the central processing unit transmits the policy number to the exclusive terminal. The exclusive terminal prepares an insurance policy to which temporarily stored data regarding the contractor himself/herself and the insurance content are printed as a record and to provide it to the user.

At the time of renewal and change of the subscribed contract content, the exclusive terminal receives the subject policy number of the subscribed insurance from the user, and transmits it to the center. The central processing unit runs searches for the presence of the contracted insurance corresponding to the received policy number for verification, and transmits a message to the exclusive terminal that it is alright to renew or change the contract. The exclusive terminal, upon receiving the message, receives data regarding the contractor himself/herself of the renewed or changed contract and the insurance content, that is, insurance renewal update information or insurance change information from the user, and temporarily stores the information inside while transmitting them to the center. The central processing unit in the center updates the corresponding data recorded in the storage based on the received insurance renewal update information or insurance change information. On the other hand, the exclusive terminal, based on the insurance renewal update information or insurance change information which are temporarily stored inside, rewrite the old insurance policy brought in by the user or prepares a new insurance policy and provide it to the user.

The Document 1 also discloses, in addition to using an insurance terminal placed at a convenience store and the like, a case where new subscription for insurance, or contract renewal through a portable terminal can be achieved using portable terminals such as mobile telephones owned by individuals as the exclusive terminals. However, in this case, insurance policies are issued by the central processing unit in the center and mailed to the user separately afterwards.

With the aforementioned related art, specifically, the technique which can achieve new subscription for insurance, contract change and the like through portable terminals such as portable telephones, subscription for insurance can be achieved whenever and wherever it is necessary. However, there are problems with the technique as described below.

One of the problems is that it is troublesome for users to manage the insurance. The reason is that it is necessary to keep the insurance policy made of paper and the like ready to be used whenever necessary in order to check the contract content and the type of the insurance the user is subscribed for whenever and wherever it is necessary. If it is not managed properly, a prompt response cannot be expected when an accident takes place which is to be covered by the insurance, or at the time of renewal of the insurance or change of the contract content.

Another problem is that it is difficult to achieve renewal of the insurance and change of the contract content promptly. The reason is that, without the insurance policy in hand, even the policy number cannot be inputted. Another reason is that, before completing the content, all the processing are performed such as: the policy number to be renewed or the contract content to be changed is transmitted from the terminal to the center; the corresponding insurance data is retrieved in the center, a message is transmitted from the center to the terminal showing that it is alright to renew the insurance; and insurance renewal update information or insurance change information is transmitted from the terminal to the center.

Still another problem is that it cannot perform control based on the insurance menu provided suitable for individual user. The reason is that information of insurance commodity used widely by unlimited number of people is installed to the terminal. Therefore, it is difficult to limit the type of the insurance to be subscribed or adjust the upper limit of the premium according to the user profiles and the like of the user.

### SUMMARY OF THE INVENTION

The present invention has been designed to overcome the foregoing problems. An object of the invention is to provide an insurance contract method and a system which makes it possible for the users to surely and easily manage the insurance which is subscribed through a portable terminal.

Another object of the invention is to provide an insurance contract method and a system which can promptly achieve renewal of the insurance subscribed through the portable terminal and change of the contract content whenever and wherever it is necessary.

Still another object of the invention is to provide an insurance contract method and a system which can perform control based on the insurance menu provided suitable for individual user.

The insurance contract method of the present invention is for transmitting, from a portable terminal to an insurance server through a network, a contract content of insurance regarding a new contract, contract change or contract renewal, whose policy number is generated on the potable terminal side while storing a normal reception message transmitted from the insurance server and the transmitted contract content in a memory of a portable terminal by corresponding them to one another. More specifically, the method comprises the steps of: installing, to a portable terminal, a software component containing a user profile, insurance commodity information, a control program for controlling a procedure for insurance contract based on the insurance commodity information, and an insurance policy data storage section; by the control of the control program, generating the contract content of insurance for a new contract, contract change, or contract renewal based on information about an insurance commodity selected by a user, data inputted by the user, the user profile, the policy number generated by the control program and the content of the insurance policy data storage section, and transmitting it to an insurance server through a network; and storing a normal reception message transmitted from the insurance server and the transmitted contract content to the insurance policy data storage section by corresponding them to one another. Also, the insurance commodity information contains information about at least one insurance commodity prepared suitable for the individual user and also restricting condition which must be satisfied at the time of preparing the contract content for the individual user so as to check the content with the restricting condition at the time of preparing the contract content.

The insurance contract method of the present invention comprises the steps of: installing, to a portable terminal, a software component containing a user profile, insurance commodity information, a control program for controlling a procedure for insurance contract based on the insurance commodity information, and an insurance policy data storage section; by the control of the control program, inputting user set items for an insurance commodity selected by a user; obtaining a present position information of the portable terminal; comparing the present position information obtained by the present position information obtaining step to base position information contained in the restricting condition of the insurance commodity information; generating contract content of insurance by the control program for a new contract, contract change or contract renewal only when the information match in the comparing step; transmitting the contract content generated by the contract generating step to an insurance server through a network; and storing a normal reception message transmitted from the insurance server and the transmitted contract content in the transmitting step to the insurance policy data storage section by corresponding them to one another.

Also, the contract method of the present invention comprises the steps of: installing, to a portable terminal, a software component containing a user profile, insurance commodity information, a control program for controlling a procedure for insurance contract based on the insurance commodity information, and an insurance policy data storage section; by the control of the control program, inputting user set items for an insurance commodity selected by a user; obtaining a present position information of the portable terminal; generating contract content of insurance by the control program for a new contract, contract change or contract renewal containing the present position information obtained in the present position obtaining step; transmitting the contract content generated by the contract generating step to an insurance server through a network; and storing a normal reception message transmitted from the insurance server and the contract content transmitted in the transmitting step to the insurance policy data storage section by corresponding them to one another.

Also, the contract method of the present invention further comprises the step of adjusting contract content by area for applying area parameter to the contract content by the insurance server based on position information at the time of contract, that is, the present position information obtained in the present position obtaining step contained in the contract contents transmitted to the insurance server in the transmitting step.

Also, the contract method of the present invention comprises the steps of: installing, to a portable terminal, a software component containing a user profile, insurance commodity information, a control program for controlling a procedure for insurance contract based on the insurance commodity information, and a software component comprising an insurance policy data storage section; by the control of the control program, inputting user set items for an insurance commodity selected by a user; obtaining a present position information of the portable terminal; generating areal contract content of insurance by the control program for a new contract, contract change or contract renewal with the present position information obtained in the present position information obtaining step as area parameter; transmitting the areal contract content generated by the areal contract generating step to an insurance server through a network; and storing a normal reception message transmitted from the insurance server and the transmitted contract contents in the transmitting step to the insurance policy data storage section by corresponding them to one another.

The contract method of the present invention comprises the steps of: installing, to a portable terminal, a software component containing a user profile, insurance commodity information, a control program for controlling a procedure for insurance contract based on the insurance commodity information, and an insurance policy data storage section; by the control of the control program, inputting user set items for an insurance commodity selected by a user; obtaining the standard time at the time of inputting user set items in the setting item input step; generating contract content of insurance by the control program for a new contract, contract change or contract renewal containing the contract time information, that is, the standard time obtained in the standard time obtaining step; transmitting the contract content generated by the contract generating step to an insurance server through a network; and storing a normal reception message transmitted from the insurance server and the transmitted contract contents in the transmitting step to the insurance policy data storage section by corresponding them to one another.

The transmitting step in the contract method of the present invention is for transmitting the contract contents generated in the contract generating step to the insurance server at a prescribed timing.

Also, the contract method of the present invention comprises the steps of: installing, to a portable terminal, a software component containing a user profile, insurance commodity information, a control program for controlling a procedure for insurance contract based on the insurance commodity information and prepaid balance, and an insurance policy data storage section; by the control of the control program, inputting user set items for an insurance commodity selected by a user; obtaining the standard time at the time of inputting user set items in the setting item input step; checking whether or not the charge of the insurance commodity selected by the user is within the prepaid balance; and generating contract content of insurance by the control program for a new contract, contract change or contract renewal containing the contract time information, that is, the standard time obtained in the standard time obtaining step only when the charge is verified to be within the prepaid balance in the checking step.

The contract method of the present invention further comprises the update step by the control program for updating the insurance commodity information by making an inquiry to the insurance server through the network.

Also, the contract method of the present invention further comprises the transfer step by the insurance server for transferring the contract content of the insurance for the new contract, contract change or the contract renewal to the designated forwarding address.

An insurance contract system of the present invention comprises an insurance server and a portable terminal capable of communicating with the insurance server through a network. The portable terminal comprises: a unit for transmitting the contract content of insurance for a new contract, contract change or contract renewal whose policy number is generated on the portable terminal side to the insurance server through the network; a unit for storing a normal reception message transmitted from the insurance server and the transmitted contract content to a memory of the portable terminal by corresponding them to one another; and a unit for displaying the content stored in the memory on a display unit. The insurance server comprises: a unit for returning the normal reception message when the contract content is normally received from the portable terminal; and a unit for recording the normally received contract contents. More specifically, the portable terminal comprises: a software component containing a user profile, insurance commodity information, a control program for controlling a procedure for insurance contract based on the insurance commodity information, and an insurance policy data storage section. The control program generates contract content of insurance for a new contract, contract change, or contract renewal based on the insurance commodity information selected by a user, data inputted by the user, the user profile, the policy number generated by the control program, and the content of the insurance policy data storage section, and transmits it to an insurance server through a network while storing a normal reception message transmitted from the insurance server and the transmitted contract content to the insurance policy data storage section by corresponding them to one another. The insurance server comprises: a unit for returning the normal reception message when the contract content is normally received from the portable terminal; and a unit for recording the normally-received contract contents. The insurance commodity information contains information about at least one insurance commodity generated suitable for the individual user and also restricting condition which must be satisfied at the time of preparing the contract content for the individual user; and the control program checks with the restricting condition at the time of preparing the contract content.

The portable terminal of the insurance contract system of the present invention further comprises a present position detection unit for detecting present position of the portable terminal. The control program compares the present position information detected by the present position information detection unit and base position information contained in the restriction condition of the insurance commodity information and generates the contract content only when the position information match.

The portable terminal of the insurance contract system of the present invention further comprises a present position information detection unit for detecting present position of the portable terminal. The insurance server applies area parameter to the contract content based on position information at the time of contract, that is, the present position information detected by the present position information detection unit contained in the contract content transmitted from the portable terminal.

The portable terminal of the insurance contract system of the present invention further comprises a present position information detection unit for detecting the present position information of the portable terminal; wherein the control program generates areal contract content of the insurance with the present position information detected by the present position information detection unit as area parameter.

The portable terminal of the insurance contract system of the present invention further comprises a standard time generating unit for generating standard time. The control program generates the contract content containing contract time information, that is, the standard time generated by the standard time generating unit.

The control program of the insurance contract system of the present invention transmits the contract content to an insurance server at a prescribed timing.

Also, the control program of the insurance contract system of the present invention updates the insurance commodity information by making an inquiry to the insurance server through the network.

The insurance server of the insurance contract system of the present invention transfers the contract content of the insurance for the new contract, contract change or the contract renewal to the designated forwarding address.

A portable terminal of the present invention is capable of communicating with an insurance server through a network and comprises: a unit for transmitting the contract content of insurance for a new contract, contract change or contract renewal, whose policy number is generated on the portable terminal side, to the insurance server through the network; a unit for storing a normal reception message transmitted from the insurance server and the transmitted contract content to a memory of the portable terminal by corresponding them to one another; and a unit for displaying the content stored in the memory on a display unit. More specifically, the portable terminal is capable of communicating with an insurance server through a network and comprises: a software component containing a user profile, insurance commodity information, a control program for controlling a procedure for insurance contract based on the insurance commodity information, and an insurance policy data storage section. The control program generates contract content of insurance for a new contract, contract change, or contract renewal based on the insurance commodity information selected by a user, data inputted by the user, the user profile, the policy number generated by the control program, and the content of the insurance policy data storage section, and transmits it to an insurance server through a network while storing a normal reception message transmitted from the insurance server and the transmitted contract content to the insurance policy data storage section by corresponding them to one another. The insurance commodity information contains information about at least one insurance commodity generated suitable for the individual user and also restricting condition which must be satisfied at the time of preparing the contract content for the individual user; and the control program checks with the restricting condition at the time of preparing the contract content.

The portable terminal of the present invention further comprises a present position information detection unit for detecting present position information of the portable terminal The control program compares the present position information detected by the present position information detection unit and a base position information contained in restricting condition of the insurance commodity information and generates the contract content only when the position information match.

The portable terminal of the present invention further comprises a present position information detection unit for detecting present position information of the portable terminal. The control program generates areal contract content of the insurance with the present position information detected by the present position information detection unit as area parameter.

The portable terminal of the present invention further comprises a standard time generating unit for generating standard time. The control program generates the contract content containing contract time information, that is, the standard time generated by the standard time generating unit.

The control program of the portable terminal of the present invention transmits the contract content to an insurance server at a prescribed timing.

A portable terminal of the present invention comprises: a software component containing user profile, insurance commodity information, a control program for controlling a procedure for insurance contract based on the insurance commodity information and prepaid balance, and an insurance policy data storage section; and a standard time generating unit for generating standard time. The control program checks whether or not the charge of the insurance commodity selected by the user is within the prepaid balance, and generates contract content of insurance for a new contract, contract change or contract renewal containing the contract time information, that is, the standard time generated by the standard time generating unit only when the charge is verified to be within the prepaid balance.

The control program of the portable terminal of the present invention updates the insurance commodity information by making an inquiry to the insurance server through the network.

An insurance contract computer program product of the present invention operates a computer to execute the processing of: transmitting, from a computer forming a portable terminal capable of communicating with an insurance server through a network to the insurance server through the network, the contract content of insurance for a new contract, contract change or contract renewal whose policy number is generated on the portable terminal side; storing a normal reception message transmitted from the insurance server and the transmitted contract content to a memory of the portable terminal by corresponding them to one another; and displaying the content stored in the memory on a display unit. More specifically, the insurance contract program is installed to a portable terminal capable of communicating with an insurance server through a network, which controls a user profile, insurance commodity information and insurance contract procedure based on the insurance commodity information. The program operates a computer to execute the processing of: generating the contract content of insurance for a new contract, contract change, or contract renewal based on insurance commodity information selected by a user, data inputted by the user, the user profile, the policy number generated by the control program and the content of the insurance policy data storage section, and transmitting it to an insurance server through a network; storing a normal reception message transmitted from the insurance server and the transmitted contract content to the insurance policy data storage section by corresponding them to one another; and displaying the contract content stored in the insurance policy data storage section on a display unit. The insurance commodity information contains information about at least one insurance commodity generated suitable for the individual user and also restricting condition which must be satisfied at the time of preparing the contract content for the individual user; and the control program checks with the restricting condition at the time of preparing the contract content.

Also, an insurance contract computer program product of the present invention is installed to a portable terminal capable of communicating with an insurance server through a network for controlling a user profile, insurance commodity information and insurance contract procedure based on the insurance commodity information. The program operates a computer to execute: a set item input processing for inputting user set items for an insurance commodity selected by a user; a present position information obtaining processing for obtaining a present position information of the portable terminal; a comparing processing for comparing the present position information obtained by the present position information obtaining step to base position information contained in the restricting condition of the insurance commodity information; a contract generating processing for generating contract content of insurance for a new contract, contract change or contract renewal only when the information match in the comparing processing; a transmitting processing for transmitting the contract contents generated by the contract generating step to an insurance server through a network; and a storing processing for storing a normal reception message transmitted from the insurance server and the contract content transmitted by the transmitting processing to the insurance policy data storage section by corresponding them to one another.

Also, an insurance contract computer program product of the present invention is installed to a portable terminal capable of communicating with an insurance server through a network for controlling a user profile, insurance commodity information and insurance contract procedure based on the insurance commodity information. The program operates a computer to execute: a set item input processing for inputting user set items for an insurance commodity selected by a user; a present position information obtaining processing for obtaining a present position information of the portable terminal; a contract generating processing for generating contract content of insurance for a new contract, contract change or contract renewal containing a present position information obtained by the present position information obtaining processing; a transmitting processing for transmitting the contract content generated by the contract generating step to an insurance server through a network; and a storing processing for storing a normal reception message transmitted from the insurance server and the contract content transmitted by the transmitting processing to the insurance policy data storage section by corresponding them to one another.

Also, an insurance contract computer program product of the present invention is installed to a portable terminal capable of communicating with an insurance server through a network for controlling a user profile, insurance commodity information and insurance contract procedure based on the insurance commodity information. The program operates a computer to execute: a set item input processing for inputting user set items for insurance commodities selected by a user; a present position information obtaining processing for obtaining a present position information of the portable terminal; an areal contract generating processing for generating areal contract content of insurance by the control program for a new contract, contract change or contract renewal with the present position information obtained in the present position information obtaining step as area parameter; a transmitting processing for transmitting the areal contract contents generated by the areal contract generating step to an insurance server through the network; and a storing processing for storing a normal reception message transmitted from the insurance server and the contract content transmitted in the transmitting step to the insurance policy data storage section by corresponding them to one another.

Also, an insurance contract computer program product program of the present invention is installed to a portable terminal capable of communicating with an insurance server through a network for controlling a user profile, insurance commodity information and insurance contract procedure based on the insurance commodity information. The program operates a computer to execute: a set item input processing for inputting user set items for an insurance commodity selected by a user; a standard time obtaining processing for obtaining the standard time at the time of inputting user set items by the set item input processing; a contract generating processing for generating contract content of insurance for a new contract, contract change or contract renewal containing the contract time information, that is, the standard time obtained by the standard time obtaining processing; a transmitting processing for transmitting the contract contents generated by the contract generating processing to an insurance server through the network; and a storing processing for storing a normal reception message transmitted from the insurance server and the contract content transmitted by the transmitting processing to the insurance policy data storage section by corresponding them to one another.

The transmitting processing of the insurance contract program of the present invention transmits the contract content generated by the contract generating processing to an insurance server at a prescribed timing.

An insurance contract computer program product of the present invention is installed to a portable terminal capable of communicating with an insurance server through a network for controlling a user profile, insurance commodity information and insurance contract procedure based on the insurance commodity information and prepaid balance. The program operates a computer to execute: a set item input processing for inputting user set items for insurance commodities selected by a user; a standard time obtaining processing for obtaining the standard time at the time of inputting user set items in the setting item input step; a checking processing for checking whether or not the charge of the insurance commodity selected by the user is within the prepaid balance; and a contract generating processing for generating contract content of insurance for a new contract, contract change or contract renewal containing the contract time information, that is, the standard time obtained in the standard time obtaining processing only when the charge is verified to be within the prepaid balance by the checking processing.

The insurance contract computer program product of the present invention further operates the computer to execute an update processing for updating the insurance commodity information by making an inquiry to the insurance server through the network.

In the present invention, the contract content of insurance transmitted to the insurance server and a normal reception message transmitted from the insurance server are stored in a memory of the portable terminal by corresponding them to one another so that the insurance which is subscribed through the portable terminal can be surely and easily managed by users. Also, the contract content of the subscribed insurance is stored in the portable terminal itself and the renewal of the insurance and change of the contract content can be completed through communicating with the insurance server only once. Thus, the user can perform renewal of the subscribed insurance and change of the contract content through the portable terminal. Furthermore, a software component containing insurance commodity information prepared suitable for individual user is installed to the portable terminal to be used. Therefore, it enables control of a new contract, contract change and contract renewal based on the insurance menu prepared suitable for individual user.

### BRIEF DESCRIPTION OF THE DRAWINGS

FIG. 1 is a block diagram of an insurance contract system according to an embodiment of the present invention;

FIG. 2 is a structural figure of a software component according to the embodiment of the present invention;

FIG. 3 is a flowchart showing a processing example performed in an agency server according to the embodiment of the present invention;

FIG. 4 is a flowchart showing an outline of a processing of a software component according to the embodiment of the present invention;

FIG. 5 is an illustration showing an initial screen displayed by the software component according to the embodiment of the present invention;

FIG. 6 is a detailed flowchart of a new contract processing performed by the software component according to the embodiment of the present invention;

FIG. 7 is an illustration showing an example of a screen showing a list of insurance name and an input screen showing user set items, which are displayed by the software component according to the embodiment of the present invention;

FIG. 8 is a detailed flowchart of the contract change processing performed by the software component according to the embodiment of the present invention;

FIG. 9 is a detailed flowchart of the subscribed contract reference processing performed by the software component according to the embodiment of the present invention;

FIG. 10 is a flowchart showing a processing example performed in an insurance server according to the embodiment of the present invention;

FIG. 11 is an illustration showing an example of the configuration of a user management table, user profile and a contract log provided in a storage of the insurance server according to the embodiment of the present invention;

FIG. 12 is a block diagram of an insurance system according to First to THIRD EXAMPLES of the present invention;

FIG. 13 is a detailed flowchart of a new contract processing performed by a software component according to the FIRST EXAMPLE of the present invention;

FIG. 14 is a detailed flowchart of the contract change processing performed by the software component according to the FIRST EXAMPLE of the present invention;

FIG. 15 is a detailed flowchart of a new contract processing performed by a software component according to the SECOND EXAMPLE of the present invention;

FIG. 16 is a detailed flowchart of the contract change processing performed by the software component according to the THIRD EXAMPLE of the present invention;

FIG. 17 is a block diagram of an insurance contract system according to a FOURTH EXAMPLE of the present invention;

FIG. 18 is a detailed flowchart of a new contract processing performed by a software component according to the FOURTH EXAMPLE of the present invention;

FIG. 19 is a detailed flowchart of a new contract processing performed by a software component according to the FOURTH EXAMPLE of the present invention;

FIG. 20 is a flowchart showing a processing example performed by the insurance server according to the FOURTH EXAMPLE of the present invention;

FIG. 21 is a block diagram of a portable terminal according to a FIFTH EXAMPLE of the present invention;

FIG. 22 is a flowchart showing a processing example performed in an agency server according to the FIFTH EXAMPLE of the present invention;

FIG. 23 is a detailed flowchart of a new contract processing performed by a software component according to the FIFTH EXAMPLE of the present invention;

FIG. 24 is a structural figure of a software component according to a SIXTH EXAMPLE of the present invention;

FIG. 25 is a detailed flowchart of a new contract processing performed by a software component according to the SIXTH EXAMPLE of the present invention;

FIG. 26 is a flowchart showing an example of update processing for insurance commodity information performed by a software component according to a SEVENTH EXAMPLE of the present invention; and

FIG. 27 is a flowchart showing an example of processing performed by an insurance server according to the SEVENTH EXAMPLE of the present invention.

### DETAILED DESCRIPTION OF THE PREFERRED EMBODIMENTS

Now, an example of an embodiment of the invention will be described in detail by referring to accompanying drawings.

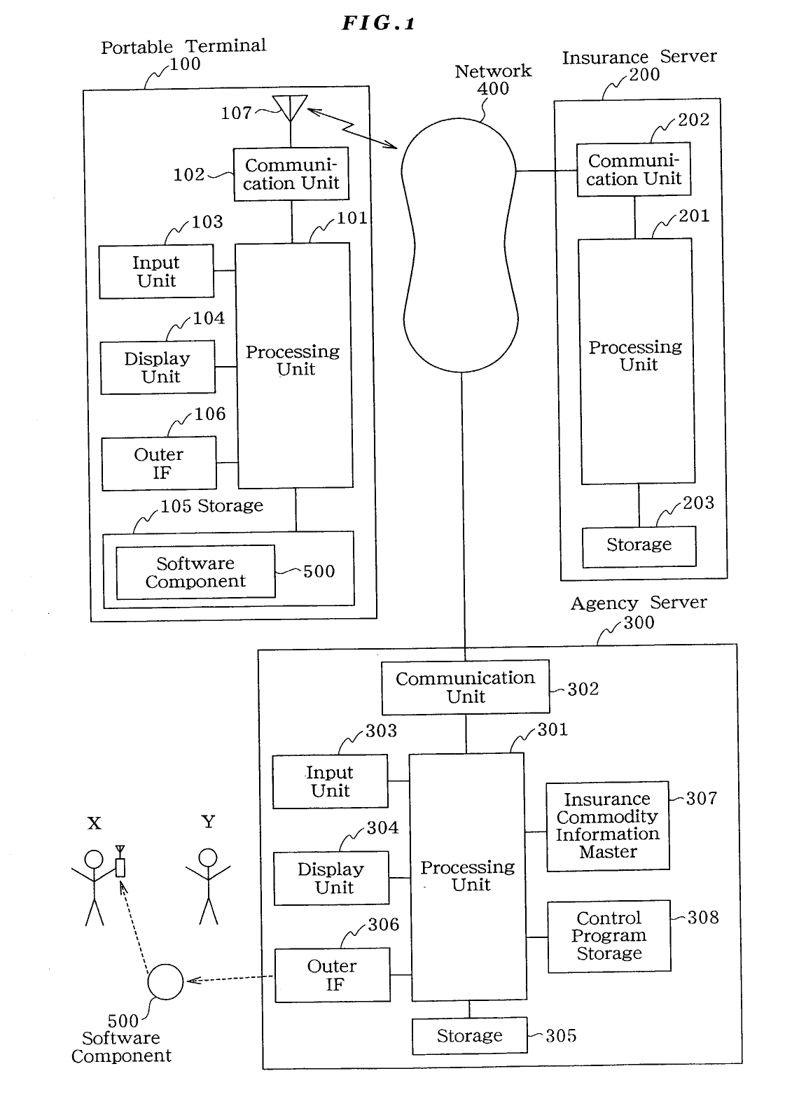

As shown in FIG. 1, an insurance contract system according to an embodiment of the present invention comprises a portable terminal 100, an insurance server 200, an agency server 300, and a communication network 400 for connecting those to one another. In FIG. 1, only one each of the portable terminal 100 and the agency server 300 is shown. However, generally, there are a plurality of them being provided.

The portable terminal 100 is a terminal used when a user subscribes for a new insurance or renews and changes the subscribed insurance. Specifically, it comprises a portable telephone and a portable information terminal with a communication function. The portable terminal 100 comprises a processing unit including an MPU, a communication unit connected thereto, an input unit 103 such as a keyboard, a display unit 104 such as an LCD, a storage 105 such as an EEPROM, and an outer interface 106 for installing a software component 500 from the outside of the portable terminal 100 to the storage 105. The communication unit 102 is connected to an antenna 107 and to the network 400 by radio contact, thereby having a function of data-communication with the insurance server 200. It is not necessary that the data-communication be performed by radio but other communication method such as cabled communication.

The insurance server 200 is a server for performing processing such as receiving the contract content and the like of the insurance for the new contract transmitted from the portable terminal 100 through the network 400 and then storing the log. Specifically, it is formed with information processing devices such as a personal computer and a work station placed at an insurance company. The insurance server 200 comprises a processing unit 201 including an MPU, a communication unit 202 connected thereto, and a storage 203 such as a magnetic disk. The communication unit 202 is cabled to the network 400 having a function of data-communication with the portable terminal 100 and the agency server 200. It is not necessary that the data-communication be performed by cable but other communication method such as radio communication.

The agency server 300 is a server for generating the software component 500 to be installed to the portable terminal 100. Specifically, it is formed with information processing devices such as a personal computer and a work station placed at an insurance agency. The agency server 300 comprises a processing unit 301 including MPU, a communication unit 302 connected thereto, an input unit 303 such as a keyboard and a mouse, a display unit 304 such as a CRT or an LCD, a storage 305 such as a magnetic disk, an outer interface 306 for installing the generated software component 500 to the portable terminal 100, an insurance commodity information master 307 for keeping various kinds of insurance commodity information which is the base for the insurance commodity information to be installed to the software component 500, and a control program storage 308 to which a control program to be installed to the software component 500 is stored. The insurance commodity information master 307 and the control program storage 308 are provided, for example, on the magnetic disk. The communication unit 302 is cabled to the network 400 with a function of data-communication with the insurance server 200. It is not necessary that the data-communication be performed by cable but other communication method such as radio communication.

Next, detailed configuration and operation of the insurance contract system according to the embodiment will be described. First, description will be made in regards to the software component 500.

In the case of the embodiment, in order for a user X who owns the portable terminal 100 to use the own portable terminal 100 as an insurance terminal, it is necessary that the user X go to the nearest insurance agency where the agency server 300 is located, and obtain the software component 500 for private use to install it to the portable terminal 100.

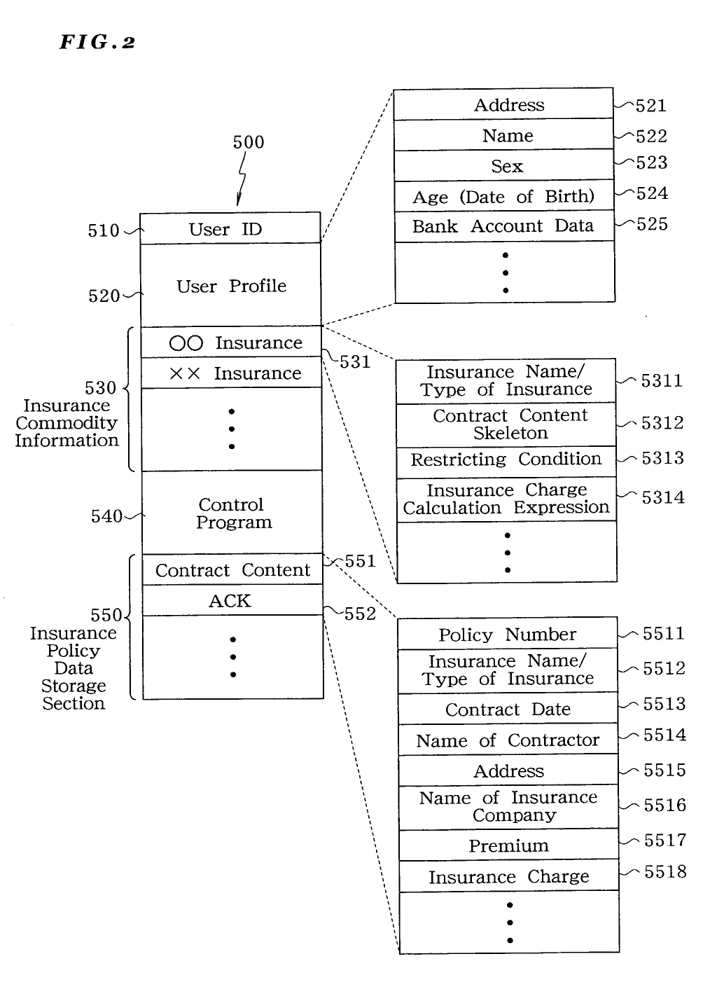

As shown in FIG. 2, the software component 500 for the user X comprises a user ID 510 for discriminating the user X from other users, a user profile 520 of the user X, an insurance commodity information 530 prepared specifically for the user X, a control program 540 for controlling the insurance contract procedure according to the insurance commodity information 530, and an insurance policy data storage section 550.

The user profile 520 includes various kinds of private information such as address 521 of the user X, name 522, sex 523, age (date of birth) 524, bank account data (name of the bank, branch, account number and so on) 525.

The insurance commodity information 530 includes all the types of insurance commodity information 531 which can be used by the user X. One insurance commodity information 531 contains insurance name/type of the insurance 5311, contract content skeleton 5312, restricting condition 5313, insurance charge calculation expression 5314 and the like. The insurance name/type of the insurance 5311 includes automobile insurance, travel insurance, life insurance, theft insurance, golf insurance, bicycle insurance and the like. In the contract content skeleton 5312, all the items to be recorded on the contract content exchanged between the insurance company and the user X are listed, in which the actual data are set for the fixed section such as the insurance company name, insurance name/type of the insurance and variables are set for the variable section such as contractor name, insured term, date of the contract, premium and the like. There are two kinds of variables. One is a variable for the user set items such as premium which is to be determined and set by the user himself/herself, and the other is variable such as the contractor name and address which are items automatically set based on the user profiles 520 and the like. In the restricting condition 5313, the restriction of the contract content which are to be satisfied at the time of new subscription for the insurance, renewal, and contract change is set beforehand with the consideration of the profile and the like of the user X. For example, in the case of life insurance in which the upper limit of the premium for the user X with the occupation at his/her age is 1,000,000 yen, the restricting condition is set to be “premium upper limit=1,000,000 yen”. Also, in the case of automobile insurance in which the upper limit of the premium for the car owned by the user is 800,000 yen for the model of the vehicle, year of the vehicle manufactured, and the price of the vehicle at the time of purchase, the restricting condition is set to be “premium upper limit=800,000 yen”. The insurance charge calculation expression 5314 is a formula for calculating the insurance charge to be collected from the user X according to the contract content set by the user X.

The control program 540 is a program executed in the portable terminal 100 to which it is installed, and controls the overall procedure for the insurance contract based on the insurance commodity information 530. For example, it manages display of the instruction panel to the display 104 for leading the operation of users, processing of new contract, contract renewal, contract change and the subscribed content reference, and recording processing of the contract content and the like in the insurance policy data storage section 550. The control program 540 is formed with, for example, Java program. Needless to say, it may be formed by other languages such as C language, machine code and the like as long as it is a system capable of being executed in the portable terminal 100. Specific processing of the control program 540 will be described later.

The insurance policy data storage section 550 is for storing the contract content of the new contract, contract content of the renewed insurance, contract content of the changed insurance together with the normal reception message transmitted from the insurance server 200. In a given contract content 551, all the items to be recorded in the contract content exchanged between the insurance company and the user X are recorded, e.g., a policy number 5511, insurance name/type of the insurance 5512, date of the contract 5513, name of the contractor 5514, address 5515, name of the insurance company 5516, premium by every insurance item 5517, insurance charge 5518. The normal reception message (ACK) 552 to be a pair with the contract content 551 is a record showing that the contract content 551 is received normally by the insurance server 200. Access to the insurance policy data storage section 550 can be performed only through the function of the control program 540. In other words, the content inside the insurance policy data storage section 550 is to be in capsule by the function of the control program 540. Thus, it is impossible to unlawfully rewrite the recorded contract content 551 and to unlawfully write in the normal reception message (ACK) 552.

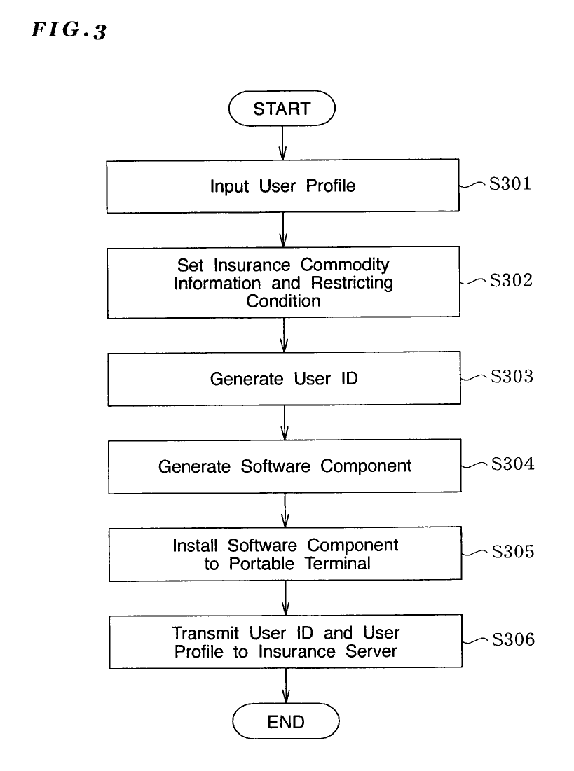

FIG. 3 shows an example of processing performed in the agency server 300 for generating the software component 500. An operator Y of the insurance agency input through the input unit 303 the user profile of the user X such as address and the name based on the statement by the user X (step S301). The inputted user profile of the user X is temporarily stored in the storage 305.

Subsequently, the operator Y determines by each insurance commodity stored in the insurance commodity information master 307 whether or not it is possible for the user X to subscribe for the commodity with the consideration of the demand by the user, the user profile and the like. If it is determined to be applicable, the operator Y determines the restricting condition to impose and prepares the insurance commodity information (insurance name/type of the insurance, the contract content skeleton, restricting condition, insurance charge calculation expression), which is specifically customized for the user X (step S302). At this point, if it is necessary to specify the subject to be insured such as in the case of automobile insurance, the model of the vehicles, license plate and the like are verified by the automobile inspection certificate to be set in the contract content skeleton in the commodity information of the automobile insurance. Also, in the case of the theft insurance, data for specifying the article to be insured is set in the contract content skeleton in the commodity information of the theft insurance. As described, the insurance commodity information and the restricting condition customized for the user X are temporarily stored in the storage 305.

Then, the operator Y starts the ID automatic numbering program which works on the processing unit 301 to generate the user ID with a prescribed figures (step S303). The generated user ID is temporarily stored in the storage 305. The generated ID may be a combination of any numbers and codes as long as it can discriminate the user from others.

Then, the operator Y starts the software component automatic generating program which works on the processing unit 301 to prepare the software component (step S304). The software component automatic generating program combines the user ID, the user profile, and the insurance commodity information stored in the storage 305 with the control program stored in the control program storage 308 thereby generating the software component 500 as described in FIG. 2 and temporarily stores it in the storage 305. A sufficient region is provided in the insurance policy data storage section 550 of the software component 500.

The operator Y then connects the outer interface 306 of the agency server 300 and the outer interface 106 of the portable terminal 100 of the user X via connection cable and installs the software component 500 for the user X stored in the storage 305 of the agency server 300 to the storage 105 of the portable terminal 100 of the user X (step S305).

Finally, the operator Y starts the forwarding program which works on the processing unit 301 to transfer the data containing the user ID and the user profile stored in the storage 305 to the insurance server 200 through the network 400 (step S306). The processing of the insurance server 200 after receiving the data from the agency server 300 will be described later. The processing of the step S305 and the processing of the step S306 may be performed at the same time, or the processing of the step S305 may be performed before the processing of the step S306.

Next, operation of the portable terminal 100 will be described in the case where the user achieves new subscription for insurance, contract renewal, contract change and the like using the portable terminal 100 to which the software component 500 is installed.

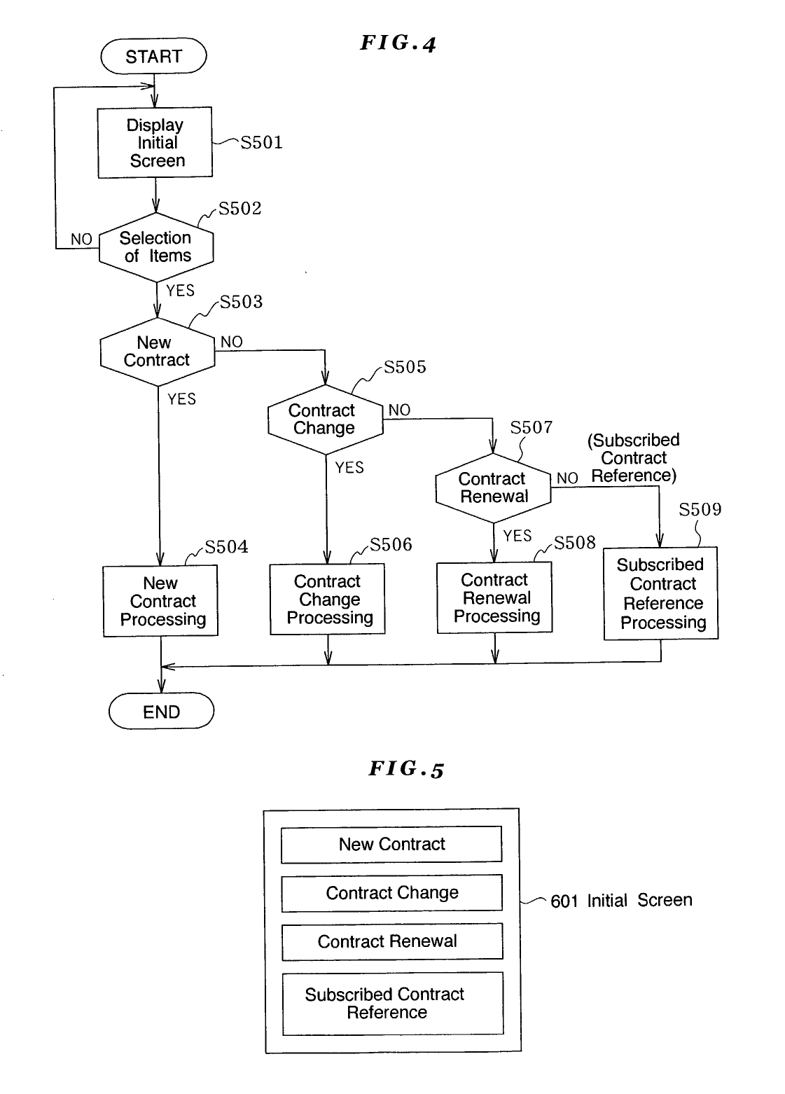

When the user X starts the control program 504 of the software component 500 through the input unit 103 of the portable terminal 100, the control program 540 is executed in the processing unit 101 and starts the processing shown in FIG. 4. First, it displays the initial screen on the display unit 104 (step S501) and waits for the user to select the items (step S502).

As shown in FIG. 5, four items including new contract, contract change, contract renewal and subscribed contract reference are displayed the initial screen 601. The user X selects new contract when he/she wishes to newly subscribe for insurance, selects the contract change when he/she wishes to change the contract content of the subscribed insurance, selects the contract renewal when he/she wishes to renew the subscribed contract, and selects subscribed contract reference when he/she wishes to check the contract content of the subscribed insurance. When the new contract is selected (YES in the step S503), the control program 540 executes the new contract processing (step S504) and when the contract change is selected (YES in the step S505), it executes the contract change processing (step S506). Also, when the contract renewal is selected (YES in the step S507), the control program 540 executes the contract renewal processing (step S508) and when the subscribed contract reference is selected (NO in the step S507), it executes the subscribed contract reference processing (step S509).

(1) New Contract

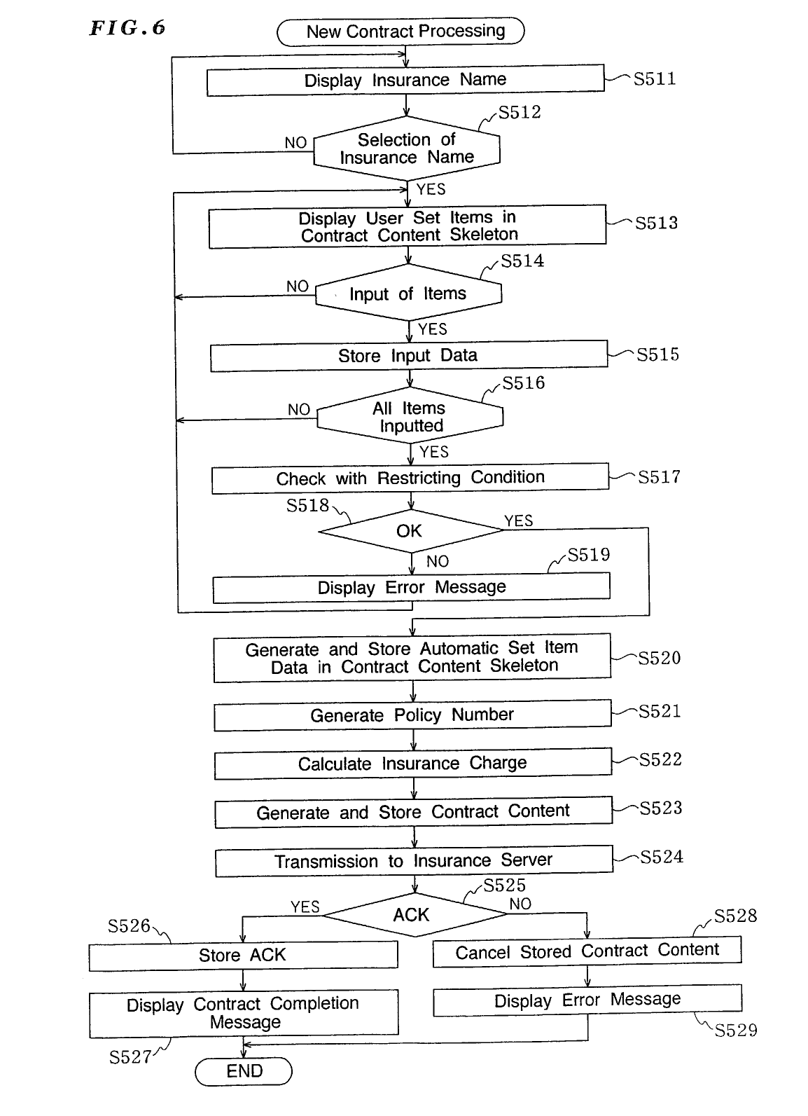

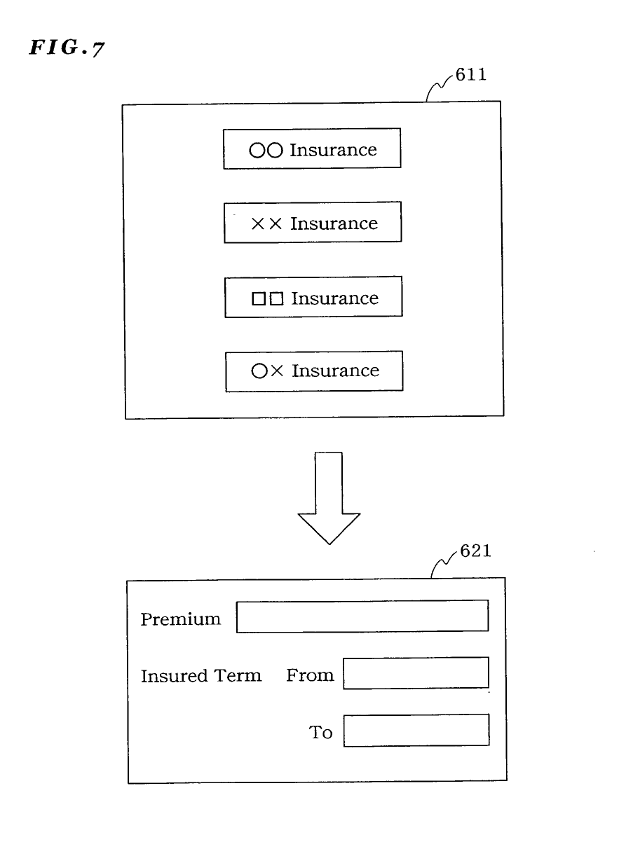

FIG. 6 shows the detail of the new contract processing in the step S504. First, the control program 540 retrieves the insurance name/type of the insurance 5311 of all the insurance commodity recorded in the insurance commodity information 530 to display the list on the display unit 104 (step S511) and waits for either one of the items to be selected (step S512). When the user X selects the name of the insurance for new subscription from the displayed list of the insurance name through the input unit 103, the control program 540 displays the input screen of the user set items in the contract content skeleton 5312 for the selected insurance on the display unit 104 (step S513), and waits for the user to input the value for each item (step S514). FIG. 7 shows an example of a list screen 611 showing insurance names and an input screen 621 of user set items. In the input screen, two items such as the premium and the insured term are displayed.

Then, the control program 540 monitors the input of data to the input items on the input screen 621. When the user X inputs data through the input unit 103, the control program 540 temporarily stores the inputted data in the work region which is provided, for example, inside the control program 540 (step S515). Then, the control program 540 checks whether or not input has been completed to all the user set items (step S516). If there is an uncompleted item, the control program 540 returns to the step S513 and waits for the user X to input and if all the items are inputted, it checks with the restricting condition 5313 set in the insurance commodity information of the insurance (step S517). For example, there is an upper limit on the premium as one of the restricting condition. If the premium inputted by the user X exceeds the upper limit designated by the restricting condition, it becomes a violation of the restricting condition (NO in the step S518). In this case, the control program 540 displays an error message on the display unit 104 showing the violation (step S519) and returns to the step S513 to let the user X perform re-input operation. In the step S517, the check routine installed in the control program 540 performs a general check, e.g., whether or not the first day of the contract term is set to be a future date of the present date (timed by clock function of the portable terminal 100) and whether or not the last day of the contract term is set to be the future date of the first day. When it is violated, the control program 540 displays an error massage (step S519) and returns to the step S513.

When the inputted values of the user set items satisfy the restricting condition and pass the general check (YES in the step S518), the control program 540 prepares the data of the automatic set items in the contract content skeleton 5312 for the selected insurance by referring to the user profile 520 and the present date, and temporarily stores the data in the work region (step S520). In other words, name of the contractor, address and the like in the automatic set items are determined by referring to the user profile 520 and the contract date is determined according to the present date.

Then, the control program 540 generates a policy number to the insurance for a new contract at this time and temporarily stores it in the work region (step S521). The policy number may be the number generated by combining the user ID 510 set in the software component 500 and, for example, a series of numbers with several figures. For example, if the user ID 510 is “12345678”, add “0001” for the first insurance policy to be “123456780001”, and add “0002” for the next insurance policy to be “123456780002”. Needless to say, the algorithm for generating the policy number is not limited to this but any algorithm can be applied.

Subsequently, the control program 540 calculates the insurance charge required for the insurance contract according to the contract content of the insurance and the insurance charge calculation expression 5314 of the insurance information, and temporarily stores it in the work region (step S522).

The control program 540 then completes the contract contents based on the contract content skeleton 5312 for the insurance, the values which are stored in the work region such as the user set items, the automatic set items, the policy number and the insurance charge, and stores it in the front portion of the vacant region of the insurance policy data storage section 550 (step S523).

The control program 540 then starts the communication unit 102 to be connected to the insurance server 200 through the network 400 and transmits to the insurance server 200 a new contract request data to which the contract content stored in the insurance policy data storage section 550 is attached (step S524). Then, the control program 540 waits for the response from the insurance server 200. Upon receiving ACK showing that the new contract request data is normally received (YES in the step S525), the control program 540 stores the ACK right after the contract content stored in the insurance policy data storage section 550 (step S526) and displays a contract completion message on the display unit 104 (step S527). Thereby, the processing shown in FIG. 6 is completed.

On the other hand, when NAK is returned from the insurance server 200 showing that the data is not received normally for unexpected reasons, the control program 540 cancels the contract content stored in the insurance policy data storage section 550 (step S528) and displays an error massage on the display unit 104 showing that the contract is not completed due to difficulties in the insurance server 200 and the like (step S529). Thereby, the processing shown in FIG. 6 is completed. In the case of receiving the NAK, the processing of the step S528 and the step S529 may be executed only when the ACK is not returned even after repeating the transmission for a limited prescribed number of times. The contract content stored in the insurance policy data storage section 550 may not have to be canceled but remained with an invalid mark.

(2) Contract Change

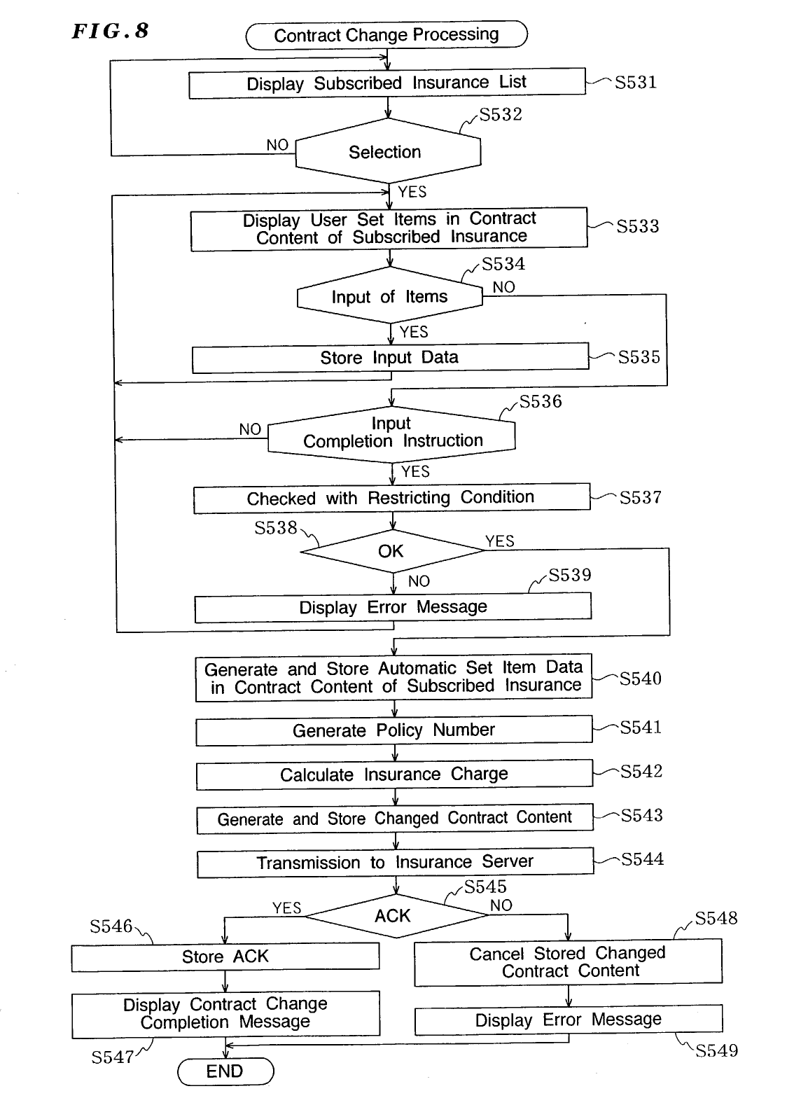

FIG. 8 shows the details of the contract change processing in the step S506 shown in FIG. 4. First, the control program 540 retrieves the insurance name/type of the insurance 5512 of all the insurance commodity recorded in the insurance policy data storage section 550 to display the list on the display unit 104 (step S531) and waits for either one of the items to be selected (step S532). When the user X selects the name of the insurance to change the contract from the displayed list of the insurance name through the input unit 103, the control program 540 displays the input screen of the user set items in the contract content 551 for the selected insurance on the display unit 104 (step S533), and waits for the user to input the value for each item (step S534). The user set items in the contract content 551 can be identified by referring to the contract content skeleton 5312 in the insurance commodity information 530 of the same insurance name. However, changing the last date of the contract term is prohibited in the contract change since the last date of the term determined in the original contract cannot be changed.

Subsequently, the control program 540 monitors the input of data to the input items on the input screen. When the user X inputs data through the input unit 103, the control program 540 temporarily stores the inputted data in the work region (step S535). Then, the control program 540 checks whether or not the user X has inputted the input completion instruction (step S536). If there is an uncompleted item, the control program 540 returns to the step S533 and waits for the user X to complete the input and, if all the items are inputted, it checks with the restricting condition 5313 set in the insurance commodity information 530 of the same insurance name (step S537). For example, there is an upper limit on the premium as one of the restricting condition. If the premium inputted by the user X exceeds the upper limit designated by the restricting condition, it becomes a violation of the restricting condition (NO in the step S538). In this case, the control program 540 displays an error message on the display unit 104 showing the violation (step S539) and returns to the step S533 to let the user X perform re-input operation. In the step S537, the check routine installed in the control program 540 performs a general check, e.g., whether or not the first day of the contract change is set to be future data of the present time and before the last day of the term. When it is violated, the control program 540 displays an error massage (step S539) and returns to the step S533.

When the inputted values of the user set items satisfy the restricting condition and pass the general check (YES in the step S538), the control program 540 prepares the automatic set item data in the contract content 551 for the selected insurance by referring to the user profile 520 and the present date and temporarily stores the data in the work region (step S540). In other words, name of the contractor, address and the like in the automatic set items are determined by referring to the user profile 520, and the contract date is determined according to the present date. The user set items in the contract content 551 can be identified by referring to the contract content skeleton 5312 in the insurance commodity information 530 of the same insurance name.

Then, the control program 540 generates a policy number for the insurance for the contract change at this time and temporarily stores it in the work region (step S541). Numbering of the policy number is performed by the same algorithm as that of the new contract. Subsequently, the control program 540 calculates the insurance charge required for the insurance contract after the change according to the changed contract content and the insurance charge calculation expression 5314 of the insurance commodity information 530 of the same insurance name, and temporarily stores it in the work region (step S542).

The control program 540 then completes the changed contract contents based on the contract content 551 before the change, the values of the user set items stored in the work region, the values of the automatic set items, the policy number, and the insurance charge, and stores it in the front portion of the vacant region of the insurance policy data storage section 550 (step S543).

The control program 540 then starts the communication unit 102 to be connected to the insurance server 200 through the network 400 and transmits to the insurance server 200 a contract change request data to which the changed contract content stored in the insurance policy data storage section 550 is attached (step S544). Then, the control program 540 waits for the response from the insurance server 200. Upon receiving ACK showing that the contract change request data is normally received (YES in the step S545), the control program 540 stores the ACK right after the changed contract content stored in the insurance policy data storage section 550 (step S546) and displays a contract change completion message on the display unit 104 (step S547). Thereby, the processing shown in FIG. 8 is completed. At this time, the contract content 551 before the change and the ACK 552 may be canceled or remained with an invalid mark. Also, the contract content 551 before the change may be remained with a mark showing that there has been a change, and the differences between the contract contents before/after the change may be stored as the contract content after the change together with the ACK.

On the other hand, when NAK is returned from the insurance server 200 showing that the data is not received normally for unexpected reasons, the control program 540 cancels the contract content stored in the insurance policy data storage section 550 (step S548), and displays an error massage on the display unit 104 showing that contract change is not completed due to difficulties in the insurance server 200 and the like (step S549). Thereby, the processing showing FIG. 8 is completed. In the case of receiving the NAK, the processing of the step S548 and the step S549 may be executed only when the ACK is not returned even after repeating the transmission for a limited prescribed number of times. The contract content stored in the insurance policy data storage section 550 may not have to be canceled but remained with an invalid mark.

(3) Contract Renewal

The flow of the contract renewal processing in the step S508 in FIG. 4 is basically the same as that of the contract change processing shown in FIG. 8. Preparation and storage of the contract content of the insurance to be renewed are performed in the step S544 after going through the same steps as the step S531 to step S542 and a contract renewal request data to which the contract content of the insurance to be renewed is attached is transmitted to the insurance server 200 in the step S544. Upon receiving the ACK from the insurance server 200 showing that the data is normally received, the ACK is recorded right after the renewed contract content stored in the insurance policy data storage section 550 in the step S546, and a contract renewal completion message is displayed on the display unit 104 in the step S547. At this time, the old contract content 551 before the renewal and the ACK 552 may be canceled or remained with an invalid mark. Also, the contract content 551 before the renewal may be remained with a mark showing that it has been renewed, and the differences between the contract contents before/after the renewal may be stored as the renewed contract content together with the ACK.

When NAK is returned from the insurance server 200 showing that the data is not received normally, the contract content to be renewed, which is stored in the insurance policy data storage section 550, is canceled in the step S548 and an error message is displayed on the display unit 104 showing that the contract renewal cannot be completed due to difficulties in the insurance server 200 and the like. The starting date and time of insurance term is automatically set to the last date and time of the original insurance contract or checked based on the restricting condition.

(4) Subscribed Contract Reference

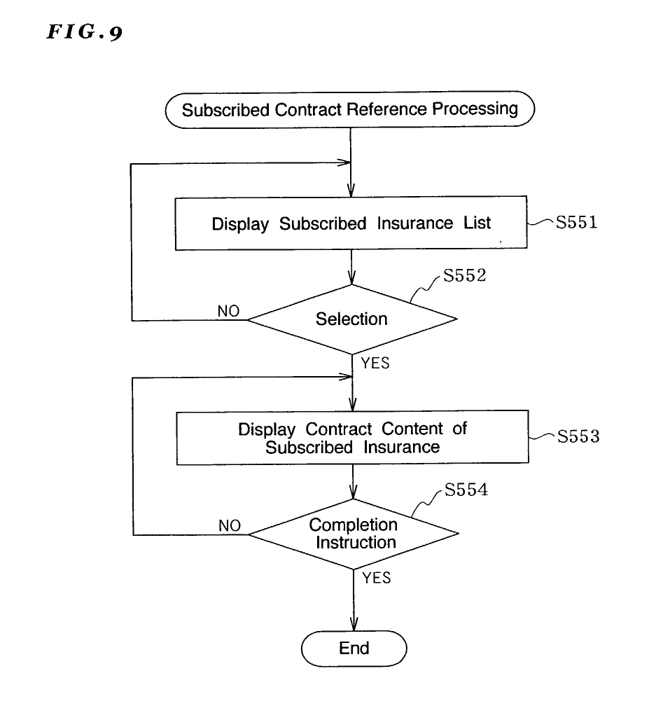

FIG. 9 shows the detail of the subscribed contract reference in the step S509 shown in FIG. 4. The control program 540 retrieves the insurance name/type of the insurance 5512 of all the insurance commodity recorded in the insurance policy data storage section 550 to display the list on the display unit 104 (step S551,) and waits for either one of the items to be selected (step S552). When the user X selects the name of the insurance for reference from the displayed list of the insurance name through the input unit 103, the control program 540 displays the input screen of the user set items in the contract content 551 for the selected insurance on the display unit 104 (step S553). When all the contract content cannot be displayed on the screen at once, it is made possible to browse all the contents by using methods such as scrolling of the screens and appointing the next page. When a completion instruction is inputted from the user X through the input unit 103 (step S554), the control program 540 completes the processing shown in FIG. 9.

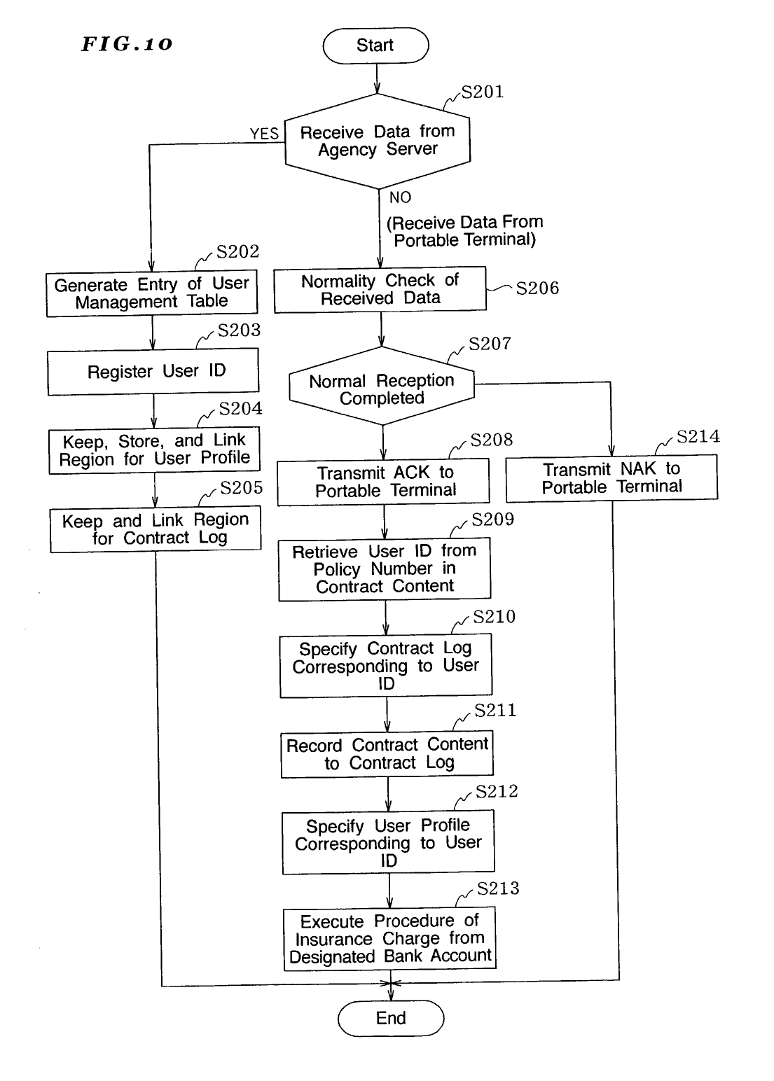

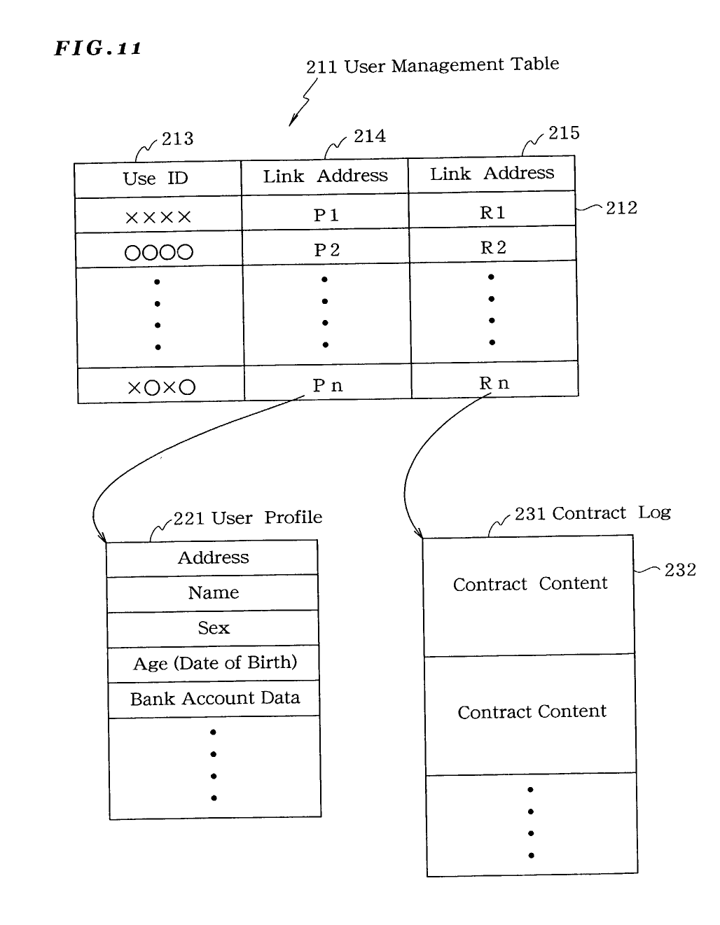

Next, the operation of the insurance server 200 will be described. FIG. 10 shows an example of processing executed in the insurance server 200, and FIG. 11 shows a structural example of a user management table 211, user profile 221 and a contract log 231 provided in a storage 203 of the insurance server 200.

As shown in FIG. 11, the user management table 211 is composed of a plurality of entries and one entry 212 comprises a user ID 213, a link address to the user profile 221, and a link address 215 to the contract log 231. The entry 212 is generated every time a new user ID and user profile is transmitted from the agency server 300. The user profile 221 is the portion for storing the user profile transmitted from the agency server 300. The contract log 331 is the portion for storing the contract content 232 transmitted from the portable terminal 100.

As shown in FIG. 10, upon receiving the user ID and user profile from the agency server 300 (YES in the step S201), the insurance server 200 generates one entry 212 in the user management table 211 (step S202) and registers the received user ID to the portion for the user ID 213 (step S203). Then, the insurance server 200 keeps the region for the user profile 221 and stores the received user profile while setting the front address of the user profile 221 in the portion of the link address 214 of the generated entry 212 in the user management table 211 (step S204). Finally, the insurance server 200 keeps the region for the contract log 231 and set the front address of the region in the portion of the link address 215 of the generated entry 212 in the user management table 221 (step S205).

On the other hand, upon receiving from the portable terminal 100 the new contract request data to which the contract content is attached, the contract change request data, and the contract renewal request data from the portable terminal 100 (NO in the step S201), the insurance server 200 checks by the error detection codes attached to the transmitted data whether or not all the data is normally received (step S206). When all the data is not received normally (NO in the step S207), the insurance server 200 transmits the NAK showing that the data is not received normally to the portable terminal 100 which is the sender of the request (step S214). Thereby, the processing shown in FIG. 10 is completed.

When all the data is completely and normally received (YES in the step S207), a normal reception message (ACK) showing that the data is normally received is transmitted to the portable terminal 100 which is the sender of the request (step S208). Then, the user ID is retrieved from the first several figures of the policy number contained in the received content (step S209) and the user management table 211 is searched using the user ID to specify the contract log 231 appointed by the link address 215 of the entry 212 with the same user ID (step S210). The received contract content is recorded in the front portion of the vacant region of the contract log 231 (step S211). Then, the user profile 221 appointed by the link address 214 of the retrieved entry 211 is specified (step S212) and the procedure is arranged for directly charging the insurance charge noted in the contract content at this time from the bank account data set in the user profile 221 (step S213). Thereby, the processing in FIG. 10 is completed. The insurance charge may be charged all together at a prescribed time such as in the end of the month instead of charging every time when receiving the new contract request data, contract change data, or contract renewal data is received from the portable terminal 100.

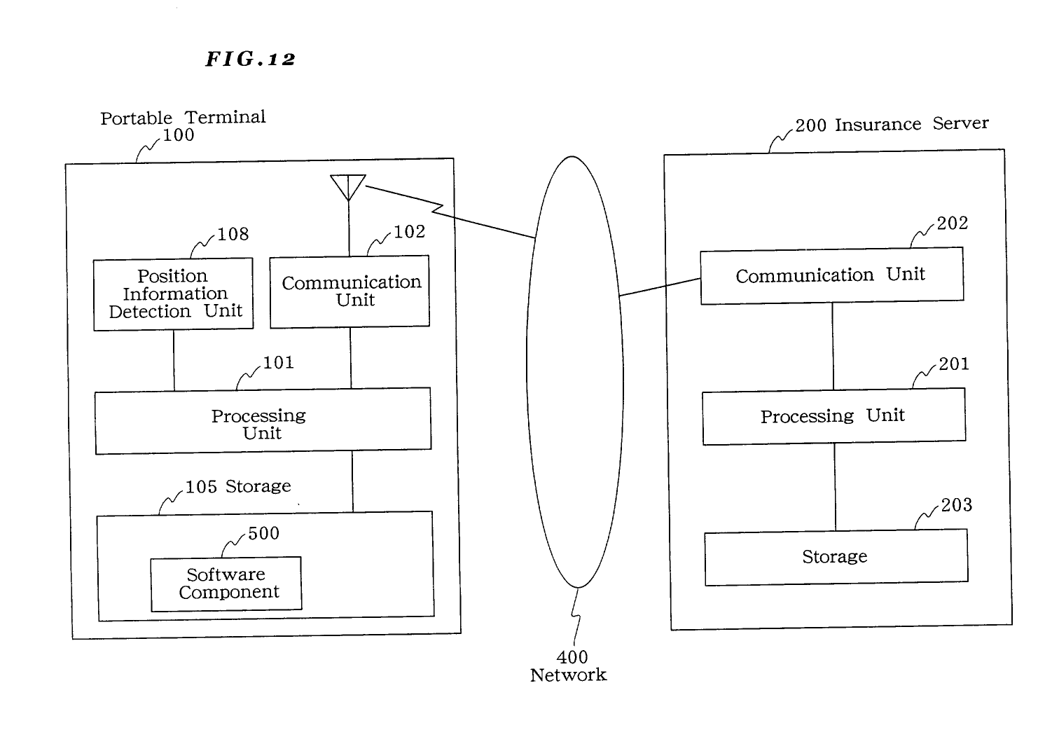

Next, EXAMPLES to which the embodiment of the invention is applied will be described. First, a FIRST EXAMPLE will be described. FIG. 12 is a simplified illustration of FIG. 1, which is simplified within a range sufficient to describe the FIRST EXAMPLE. The FIRST EXAMPLE as shown in FIG. 12 has a configuration in which a position information detection unit 108 is added to the portable terminal 100 shown in FIG. 1.

The position information detection unit 108 detects the present position of the portable terminal 100. Specifically, a GPS (Global Positioning System) may be mounted to use methods such as specifying the present position by receiving radio waves from a satellite, or specifying the area of the present position through specifying the radio base station which is used by the portable terminal 100 at that point. However, the method is not limited to these but any method may be applicable as long as it can specify the position. Also, when the information which can specify the position is obtained from the communication unit 102, the communication unit 102 may also serve as the position information detection unit. When the information from the communication unit 102 is processed in the processing unit 101 to be used as the position information, the processing unit 101 may also serve as the position information detection unit.

The basic configuration of the software component 500 for the user X in the FIRST EXAMPLE is the same as that shown in FIG. 2. The difference in the EXAMPLE is that an item of base position information is set in the restricting condition 5313. The base position information is to designate a position beforehand where contract can be exchanged or renewed. For example, when the user X subscribes for an automobile insurance, contract or renewal in the position of the parking lot (garage) is designated beforehand. This is an item for the user X to report in the processing of generating the software component 500 shown in FIG. 3. The operator Y in the agency server 300 is to set it as a restricting condition 5313 when preparing the insurance commodity information customized for the user X (step S302).

Then, in the insurance policy data storage section 550, an item of contract time position information is set in the contract content 551 shown in FIG. 2 in addition to the policy numbers and the like 5511 to 5518.

The processing of generating the software component 500 is basically the same as the processing shown in FIG. 3. The differences are that the restricting condition 5313 of the insurance commodity information 530 is improved as described, the control program 540 can process the position information transmitted from the position information detection unit 108, and the region of the insurance policy data storage section 550 is kept so as to be able to store the contract time position information and the base position information.

The agency server 300 installs the prepared software component to the portable terminal 100 by various methods. Also, it transmits the user ID 510, the user profile 520 and the base contract content to the insurance server 200.

Next, described is the operation in the case where the user performs the insurance contract by using the portable terminal 100 to which the software component 500 of the FIRST EXAMPLE is installed. The selection processing of new contract, contract change, contract renewal, and the subscribed contract reference by the user is the same as that in the embodiment as the base shown in FIG. 4 and FIG. 5.

(1) New Contract

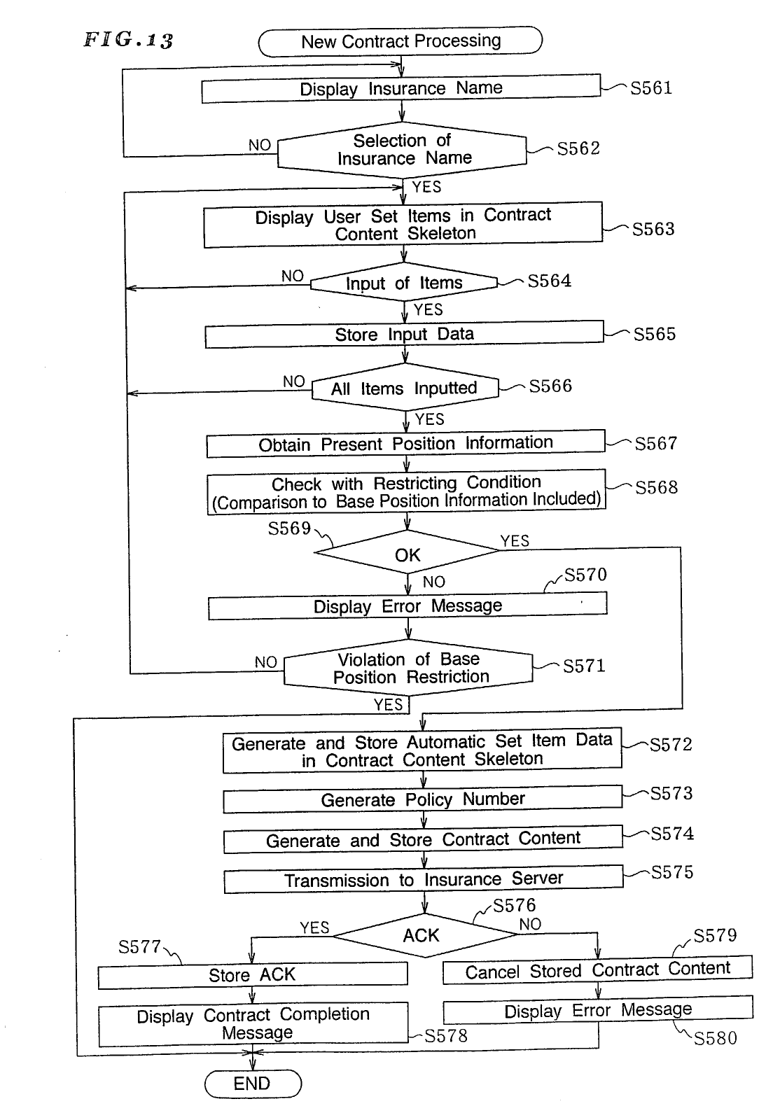

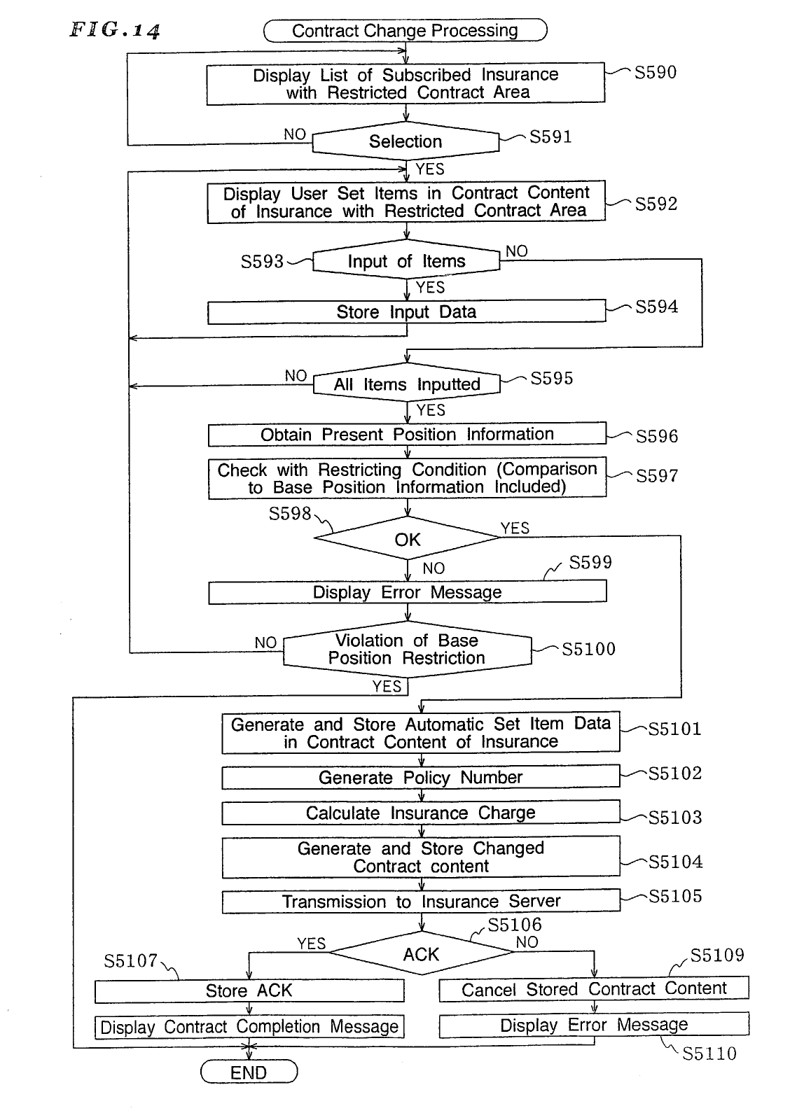

FIG. 13 shows the detail of the new contract processing in the step S504. First, the control program 540 retrieves the insurance name/type of the insurance 5311 of all the insurance commodity recorded in the insurance commodity information 530 to display the list on the display unit 104 (step S561) and waits for either one of the items to be selected (step S562). When the user X selects the name of the insurance for new subscription from the displayed list of the insurance name through the input unit 103, the control program 540 displays the input screen of the user set items in the contract content skeleton 5312 for the selected insurance on the display unit 104 (step S563), and waits for the user to input the value for each item (step S564). FIG. 7 shows an example of a list screen 611 showing insurance names and an input screen 621 of user set items. In the input screen, two items such as the premium and the insured term are displayed.

Then, the control program 540 monitors the input of data to the input items on the input screen 621. When the user X inputs data through the input unit 103, the control program 540 temporarily stores the inputted data in the work region (step S565). Then, the control program 540 checks whether or not input has been completed to all the user set items (step S566). If there is an uncompleted item, the control program 540 returns to the step S563 and waits for the user X to input and if all the items are inputted, it obtains the present position information of the portable terminal 100 from the position information detection unit 108 and temporarily stores it in the work region (step S567).

Subsequently, the control program 540 checks with the restricting condition set in the insurance commodity information of the insurance (step S568). In the EXAMPLE, the restriction based on the base position information is also set in addition to the restriction based on the insurance charge as in the base embodiment. In other words, the control program 540 compares the present position information obtained in the step S567 to the base position information which is set beforehand. When the position does not match, it becomes a violation of the restricting condition (NO in the step S569). In this case, the control program 540 displays a corresponding error message on the display unit 104 (step S570). When it is the violation of the insurance charge or the like in the restricting condition, the control program 540 displays a corresponding error message on the display unit 104 (step S570).

When it is the violation of the restricting condition due to the unmatched position information (YES in the step 571), the processing is completed. The user X is to move to the base position set beforehand to perform the contract procedure again. Thereby, it can highly increase the possibility that the person designates the base position information beforehand and the person performs the contract procedure are the same. Hence, it is effective for improving security management. Also, it can prevent the case where an accident takes place after the user X actually leaves the position, or such act that the user subscribes for insurance right before an accident. Hence, it is effective to prevent an improper use.

When it is a violation of the restricting condition other than the unmatched position information in the step S571 (NO in the step 571), the control program 540 returns to the step S563 to let the user X perform re-input operation. In the step 568, the check routine installed to the control program 540 performs a general check, e.g., whether or not the first day of the contract term is set to be future date of the present date (timed by clock function of the portable terminal 100) and whether or not the last day of the contract term is set to be the future date of the first day. When it is violated, the control program 540 displays a corresponding error massage (step S570) and returns to the step S563.

When the inputted values of the user set items satisfy the restricting condition and pass the general check (YES in the step S569), the control program 540 prepares the automatic set item data in the contract content skeleton 5312 for the selected insurance by referring to the user profile 520 and the present date, and temporarily stores the data in the work region (step S572). In other words, name of the contractor, address and the like in the automatic set items are determined by referring to the user profile 520 and the contract date is determined according to the present date.

Then, the control program 540 generates a policy number for the insurance for new contract at this time and temporarily stores it in the work region (step S573). The policy number may be the number obtained by combining the user ID 510 set in the software component 500 with, for example, a series of numbers with several figures.

The control program 540 then completes the contract contents based on the contract content skeleton 5312 for the insurance, the values of the user set items stored in the work region, the values of the automatic set items, the policy number, the insurance charge, and the contract time position information, and stores it in the front portion of the vacant region of the insurance policy data storage section 550 (step S574). In the EXAMPLE, the present position information obtained in the step S567 is also stored as the contract time position information.

The control program 540 then starts the communication unit 102 to be connected to the insurance server 200 through the network 400 and transmits to the insurance server 200 a new contract request data to which the contract content stored in the insurance policy data storage section 550 is attached (step S575).

Then, the control program 540 waits for the response from the insurance server 200. Upon receiving ACK showing that the new contract request data is normally received (YES in the step S576), the control program 540 stores the ACK right after the contract content stored in the insurance policy data storage section 550 (step S577) and displays a contract completion message on the display unit 104 (step S578). Thereby, the processing shown in FIG. 13 is completed.

On the other hand, when NAK is returned from the insurance server 200 showing that the data is not received normally for unexpected reasons (NO in the step S567), the control program 540 cancels the contract content stored in the insurance policy data storage section 550 (step S579) and displays an error massage on the display unit 104 showing that the contract is not completed due to difficulties in the insurance server 200 and the like (step S580). Thereby, the processing showing FIG. 13 is completed. In the case of receiving the NAK, the processing of the step S579 and the step S580 may be executed only when the ACK is not returned even after repeating the transmission for a limited prescribed number of times. The contract content stored in the insurance policy data storage section 550 may not have to be canceled but remained with an invalid mark.

(2) Contract Change (3) Contract Renewal

FIG. 14 shows the detail of the contract change and contract renewal processing of the step S506 and S508 in the EXAMPLE. It is basically the same as the processing in the base embodiment shown in FIG. 8. The difference is that the control program 540 obtains the present position information in the step S596. The obtained present (contract) position information is used when judging whether or not there is a violation of the restricting condition by making a comparison to the set base position information. The reason for using each of the present (contract) position information is the same as that described in (1) New Contract of the EXAMPLE.

As for the contract change and contract renewal, when there is an actual change being made or it is almost the contract renewal date, it is preferable that the content be reflected in the insurance server 200 as much as possible. Thus, there may be a case where the comparison of the present position information to the base position information as the restricting condition may not be carried out. Therefore, unlike the case of new contract, the insurance company may set the item in each insurance commodity information 531 not to make the comparison of the present position information to the base position information as the restricting condition in the case of contract change and contract renewal.

(4) Subscribed Contract Reference

The subscribed contract reference processing of the step S509 in the EXAMPLE is the same as that of the base embodiment shown in FIG. 9.

The operation of the insurance server 200 in the EXAMPLE is as same as that of the base embodiment shown in FIG. 10 and FIG. 11.

The FIRST EXAMPLE has been described heretofore, however, the invention is not limited to this but various kinds of modifications as described hereinafter are possible.

A plurality of base position information may be provided. For example, it makes it possible to subscribe for insurance at a plurality of positions such as the parking lot at home and the parking lot at work.

A method of changing the base position information may be provided. For example, when a user moves out to a new address or goes on a trip, the user requests a base position information change by the communication between the terminal and the insurance server through a network. In this case, credibility can be improved by going through the procedure such as requiring a password.

There may be a margin to some extent provided for the base position information. For example, by setting the Base Position to be within the area of Chiba Prefecture, an insurance commodity can be prepared in which auto accident rate in the prefecture is added to the insurance charge rate to be considered, which can be only subscribed within the area of Chiba Prefecture. In this case, it may also add a function of monitoring the present position information using the terminal by a certain time to check whether or not it is within the base position information. If it is outside the set area, the contract becomes invalid, and if it is to be out of the region, subscription for insurance within the neighboring region is performed.

Effect of the FIRST EXAMPLE

With the EXAMPLE as described, effects as described hereinafter can be obtained.

It can improve the security level for users by using the system. The reason is that it can highly increase the possibility that the person designates the base position information beforehand and the person performs the contract procedure are the same by making a comparison of the base position information set beforehand to the position information where the contract procedure is performed.

It prevents a risk of improper use for the insurance company by using the system, which may otherwise occur due to contracts not exchanged over the counter. The reason is that it can prevent a case where an accident occurs after the user X actually leaves the position or such act that the user subscribes for insurance right before an accident by making a comparison of the base position information set beforehand to the position information where the contract procedure is performed.

Insurance companies can provide new insurance commodities such as a limited area type to which a restriction is imposed on the contract position. The reason is that it can add a control on the procedure for the insurance contract based on the base position information.

Next, a SECOND EXAMPLE will be described. FIG. 12 is a simplified illustration of FIG. 1, which is simplified within a range sufficient to describe the SECOND EXAMPLE. The SECOND EXAMPLE as shown in FIG. 12, as in the case of the FIRST EXAMPLE, has a configuration in which a position information detection unit 108 is added to the portable terminal 100 shown in FIG. 1.

The position information detection unit 108 detects the present position of the portable terminal 100. Specifically, a GPS (Global Positioning System) may be mounted to use methods such as specifying the present position by receiving radio waves from a satellite, or specifying the area of the present position through specifying the radio base station which is used by the portable terminal 100 at that point. However, the method is not limited to these but any method may be applicable as long as it can specify the position. Also, when the information which can specify the position is obtained from the communication unit 102, the communication unit 102 may also serve as the position information detection unit. When the information from the communication unit 102 is processed in the processing unit 101 to be used as the position information, the processing unit 101 may also serve as the position information detection unit.

The basic configuration of the software component 500 for the user X in the SECOND EXAMPLE is the same as that shown in FIG. 2. The difference in the EXAMPLE is that, in the insurance policy data storage section 550, an item of contract time position information is set in the contract content 551 shown in FIG. 2 in addition to the policy numbers and the like 5511 to 5518.

The processing of generating the software component 500 is basically as same as that shown in FIG. 3. The differences are that the control program 540 can also control the position information detection unit 108 and keeps the region of the insurance policy data storage section 550 so as to be able to store the contract time position information.

The agency server 300 installs the prepared software component to the portable terminal 100 by various methods. Also, it transmits the user ID 510, the user profile 520 and the base contract content to the insurance server 200.

Next, described is the operation in the case where the user performs the insurance contract by using the portable terminal 100 to which the software component 500 of the SECOND EXAMPLE is installed. The selection processing of new contract, contract change, contract renewal, and the subscribed contract reference by the user is the same as that in the embodiment as the base shown in FIG. 4 and FIG. 5.

(1) New Contract

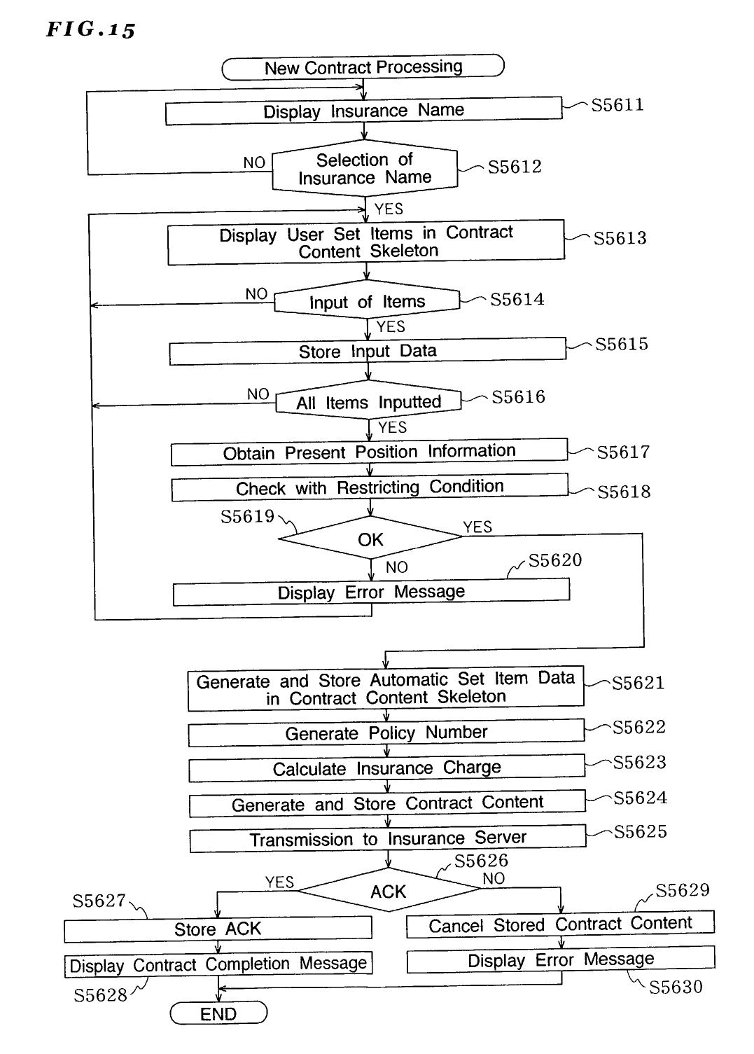

FIG. 15 shows the detail of the new contract processing of the step S504 in the EXAMPLE. First, the control program 540 retrieves the insurance name/type of the insurance 5311 of all the insurance commodity recorded in the insurance commodity information 530 to display the list on the display unit 104 (step S5611) and waits for either one of the items to be selected (step S5612). When the user X selects the name of the insurance for new subscription from the displayed list of the insurance name through the input unit 103, the control program 540 displays the input screen of the user set items in the contract content skeleton 5312 for the selected insurance on the display unit 104 (step S5613), and waits for the user to input the value for each item (step S5614). FIG. 7 shows an example of a list screen 611 showing insurance names and an input screen 621 of user set items. In the input screen, two items such as the premium and the insured term are displayed.

Then, the control program 540 monitors the input of data to the input items on the input screen 621. When the user X inputs data through the input unit 103, the control program 540 temporarily stores the inputted data in the work region (step S5615). Then, the control program 540 checks whether or not input has been completed to all the user set items (step S5616). If there is an uncompleted item, the control program 540 returns to the step S5613 and waits for the user X to input and if all the items are inputted, it obtains the present position information of the portable terminal 100 from the position information detection unit 108 and temporarily stores it in the work region (step S5617).

Subsequently, the control program 540 checks with the restricting condition set in the insurance commodity information of the insurance (step S5618). When there is a violation of the restricting condition (NO in the step S5619), the control program 540 displays a corresponding error message on the display unit 104 (step S5620), and returns to the step S5613 to let the user X perform re-input operation. In the step S5618, the check routine installed in the control program 540 performs a general check, e.g., whether or not the first day of the contract term is set to be future date of the present date (timed by clock function of the portable terminal 100) and whether or not the last day of the contract term is set to be the future date of the first day. When it is violated, the control program 540 displays a corresponding error massage (step S5620) and returns to the step S5613.

When the inputted values of the user set items satisfy the restricting condition and pass the general check (YES in the step S5619), the control program 540 prepares the automatic set item data in the contract content skeleton 5312 for the selected insurance by referring to the user profile 520 and the present date, and temporarily stores the data in the work region (step S5621). In other words, name of the contractor, address and the like in the automatic set items are determined by referring to the user profile 520 and the contract date is determined according to the present date.

Then, the control program 540 generates a policy number for the insurance for new contract at this time and temporarily stores it in the work region (step S5622). The policy number may be the number obtained by combining the user ID 510 set in the software component 500 with, for example, a series of numbers with several figures. Subsequently, the control program 540 calculates the insurance charge required for the insurance contract according to the contract content of the insurance and the insurance charge calculation expression 5314 of the insurance information, and temporarily stores it in the work region (step S5623).

The control program 540 then completes the contract contents based on the contract content skeleton 5312 for the insurance, the values which are stored in the work region such as the user set items, the automatic set items, the policy number, the insurance charge, and the contract time position information, and stores it in the front portion of the vacant region of the insurance policy data storage section 550 (step S5624). In the EXAMPLE, the present position information obtained in the step S5617 is also stored as the contract time position information.

The control program 540 then starts the communication unit 102 to be connected to the insurance server 200 through the network 400 and transmits to the insurance server 200 a new contract request data to which the contract content stored in the insurance policy data storage section 550 is attached (step S5625). In the EXAMPLE, the contract time position information is also transmitted to the insurance server 200. Thus, insurance companies can use the contract time position information when conducting investigation in the case where the system is improperly used. For example, if a contract is subscribed near the accident scene just before an accident takes place, it can be suspected as a subject of an investigation.

Then, the control program 540 waits for the response from the insurance server 200. Upon receiving ACK showing that the new contract request data is normally received (YES in the step S5626), the control program 540 stores the ACK right after the contract content stored in the insurance policy data storage section 550 (step S5627) and displays a contract completion message on the display unit 104 (step S5628). Thereby, the processing shown in FIG. 15 is completed.

On the other hand, when NAK is returned from the insurance server 200 showing that the data is not received normally for unexpected reasons, the control program 540 cancels the contract content stored in the insurance policy data storage section 550 (step S5629) and displays an error massage on the display unit 104 showing that the contract is not completed due to difficulties in the insurance server 200 and the like (step S5630). Thereby, the processing shown in FIG. 15 is completed. In the case of receiving the NAK, the processing of the step S5629 and the step S5630 may be executed only when the ACK is not returned even after repeating the transmission for a limited prescribed number of times. The contract content stored in the insurance policy data storage section 550 may not have to be canceled but remained with an invalid mark.

(2) Contract Change (3) Contract Renewal

The processing of the contract change and contract renewal in the step S506 and S508 in the EXAMPLE is basically the same as that in the base embodiment shown in FIG. 8. The difference is that the control program 540 obtains the present position information. The obtained present (contract) position information is used to be transmitted as the changed contract content. The reason for using each present (contract) position is the same as that described in (1) New Contract of the EXAMPLE.

(4) Subscribed Contract Reference

The subscribed contract reference of the step S509 in the EXAMPLE is the same as the base embodiment shown in FIG. 9.

The operation of the insurance server 200 in the EXAMPLE is the same as that in the base embodiment shown in FIG. 10 and FIG. 11. The difference is that the contract time position information is contained in the contract content 232 of the contract log 231 shown in FIG. 11. Hence, insurance companies can record the contract position so as to be able to use it as a clue for investigation when there are unlawful acts such as insurance fraud and the like. This is an effect for reducing the risk of contracts not exchanged over the counter.

Also, insurance companies can change the condition based on the contract time position information such as charge or premium determined based on the record of the contract time position information in the contract log 231. For example, an insurance company can set a high insurance charge for insurance contracted in prefectures or areas with a high auto accident rate and a low insurance charge for insurance contracted in prefectures or areas with a low auto accident rate.

The SECOND EXAMPLE has been described heretofore, however, the invention is not limited to this but various kinds of modifications are possible.

Within the contracted term of the insurance, each of the position information is transmitted by the terminal software component to the insurance server by a certain time to record it therein. Thereby, the insurance company can obtain information such as moving path and the speed within the insured term and based on this, it can prevent the improper use and achieve change of the charging condition.

Effects of the SECOND EXAMPLE

With the EXAMPLE as described, effects as described hereinafter can be obtained.

It prevents a risk of improper use for the insurance company by using the system, which may otherwise occur due to contracts not exchanged over the counter. The reason is that it can record the contract position so as to be used as a clue for investigation when there are unlawful acts such as insurance fraud and the like.

The insurance company can change the condition such as the charge based on the contract time position information of the insurance. The reason is that the contract time position information is recorded in the contract log to be referred at the time of charge.

Next, a THIRD EXAMPLE will be described. FIG. 12 is a simplified illustration of FIG. 1, which is simplified within a range sufficient to describe the THIRD EXAMPLE. The THIRD EXAMPLE as shown in FIG. 12, as in the case of the FIRST EXAMPLE and SECOND EXAMPLE, has a configuration in which a position information detection unit 108 is added to the portable terminal 100 shown in FIG. 1.

The position information detection unit 108 detects the present position of the portable terminal 100. Specifically, a GPS (Global Positioning System) may be mounted to use methods such as specifying the present position by receiving radio waves from a satellite, or specifying the area of the present position through specifying the radio base station which is used by the portable terminal 100 at that point. However, the method is not limited to these but any method may be applicable as long as it can specify the position. Also, when the information which can specify the position is obtained from the communication unit 102, the communication unit 102 may also serve as the position information detection unit. When the information from the communication unit 102 is processed in the processing unit 101 to be used as the position information, the processing unit 101 may also serve as the position information detection unit.

The basic configuration of the software component 500 for the user X in the THIRD EXAMPLE is the same as that shown in FIG. 2. The difference in the EXAMPLE is that an insurance commodity whose condition such as insurance charge varies according to the position information is added to a type of the insurance commodity 5311 which is contained in the insurance commodity information 530. This type of insurance is suitable mainly for automobile insurance and the like and, for example, the insurance charge can be set with the consideration of the auto accident rate in the surrounding area where the contract is exchanged. In other words, a high insurance charge can be set for the insurance subscribed in prefectures or areas with a high auto accident rate and a low insurance charge can be set for the insurance subscribed in prefectures or areas with a low auto accident rate. The items as described are set in the contract content skeleton 5312, the restricting condition 5313, and the insurance charge calculation expression 5314. In this case, specifically, one or more functions for calculating the insurance charge is set in the insurance charge calculation expression 5314 based on the contract time position information.

Then, in the insurance policy data storage section 550, an item of contract time position information is set in the contract content 551 shown in FIG. 2 in addition to the policy numbers and the like 5511 to 5518.

The processing of generating the software component 500 is basically the same as the processing shown in FIG. 3. The differences are that the contract content skeleton 5312, the restricting condition 5313, and the insurance charge calculation expression 5314 of the insurance commodity information 530 are improved as described, the control program 540 can process the position information from the position information detection unit 108, and the region of the insurance policy data storage section 550 is kept so as to be able to store the contract time position information and the base position information.

The agency server 300 installs the prepared software component to the portable terminal 100 by various methods. Also, it transmits the user ID 510, the user profile 520 and the base contract content to the insurance server 200.

Next, described is the operation in the case where the user achieves the insurance contract by using the portable terminal 100 to which the software component 500 of the THIRD EXAMPLE is installed. The selection processing of new contract, contract change, contract renewal and the subscribed contract reference by the user is the same as that in the embodiment as the base shown in FIG. 4 and FIG. 5.

(1) New Contract

FIG. 15 shows the detail of the new contract processing of the step S504 in the EXAMPLE. First, the control program 540 retrieves the insurance name/type of the insurance 5311 of all the insurance commodity recorded in the insurance commodity information 530 to display the list on the display unit 104 (step S5611) and waits for either one of the items to be selected (step S5612). When the user X selects the name of the insurance for new subscription from the displayed list of the insurance name through the input unit 103, the control program 540 displays the input screen of the user set items in the contract content skeleton 5312 for the selected insurance on the display unit 104 (step S5613), and waits for the user to input the value for each item (step S5614). In the input screen, two items such as the premium and the insured term are displayed.

Then, the control program 540 monitors the input of data to the input items on the input screen 621. When the user X inputs data through the input unit 103, the control program 540 temporarily stores the inputted data in the work region (step S5615). Then, the control program 540 checks whether or not input has been completed to all the user set items (step S5616). If there is an uncompleted item, the control program 540 returns to the step S5613 and waits for the user X to input and if all the items are inputted, it obtains the present position information of the portable terminal 100 from the position information detection unit 108 and temporarily stores it in the work region (step S5617).

Subsequently, the control program 540 checks with the restricting condition (step S5618). When there is a violation of the restricting condition (NO in the step S5619), the control program 540 displays a corresponding error message on the display unit 104 (step S5620), and returns to the step S5613 to let the user X perform re-input operation. In the step S5618, the check routine installed to the control program 540 performs a general check, e.g., whether or not the first day of the contract term is set to be a future date of the present date (timed by clock function of the portable terminal 100) and whether or not the last day of the contract term is set to be the future date of the first day. When it is violated, the control program 540 displays a corresponding error massage (step S5620) and returns to the step S5613.

When the inputted values of the user set items satisfy the restricting condition and pass the general check (YES in the step S5619), the control program 540 prepares the automatic set item data in the contract content skeleton 5312 for the selected insurance by referring to the user profile 520 and the present date, and temporarily stores the data in the work region (step S5621). In other words, name of the contractor, address and the like in the automatic set items are determined by referring to the user profile 520 and the contract date is determined according to the present date.

Then, the control program 540 generates a policy number for the insurance for new contract at this time and temporarily stores it in the work region (step S5622). The policy number may be the number generated by combining the user ID 510 set in the software component 500 with, for example, a series of numbers with several figures. Subsequently, the control program 540 calculates the insurance charge required for the insurance contract according to the contract content of the insurance and the insurance charge calculation expression 5314 of the insurance information, and temporarily stores it in the work region (step S5623).

The control program 540 then completes the contract contents based on the contract content skeleton 5312 for the insurance, the values which are stored in the work region such as the user set items, the automatic set items, the policy number, the insurance charge and the contract time position information, and stores it in the front portion of the vacant region of the insurance policy data storage section 550 (step S5624).

The control program 540 then starts the communication unit 102 to be connected to the insurance server 200 through the network 400 and transmits to the insurance server 200 a new contract request data to which the contract content stored in the insurance policy data storage section 550 is attached (step S5625).

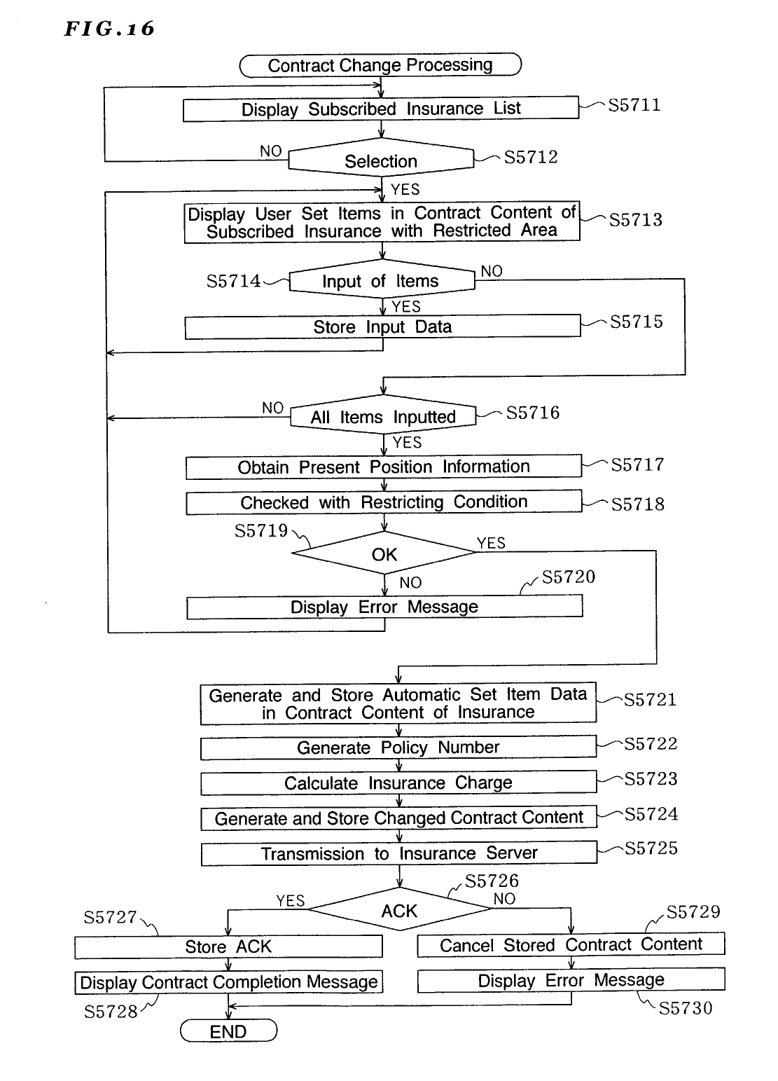

Then, the control program 540 waits for the response from the insurance server 200. Upon receiving ACK showing that the new contract request data is normally received (YES in the step S5626), the control program 540 stores the ACK right after the contract content stored in the insurance policy data storage section 550 (step S5627) and displays a contract completion message on the display unit 104 (step S5628). Thereby, the processing shown in FIG. 16 is completed.

On the other hand, when NAK is returned from the insurance server 200 showing that the data is not received normally for unexpected reasons, the control program 540 cancels the contract content stored in the insurance policy data storage section 550 (step S5629), and displays an error massage on the display unit 104 showing that the contract is not completed due to difficulties in the insurance server 200 and the like (step S5630). Thereby, the processing showing FIG. 16 is completed. In the case of receiving the NAK, the processing of the step S5629 and the step S5630 may be executed only when the ACK is not returned even after repeating the transmission for a limited prescribed number of times. The contract content stored in the insurance policy data storage section 550 may not have to be canceled but remained with an invalid mark.

(2) Contract Change (3) Contract Renewal

FIG. 16 shows the processing of the contract change and contract renewal in the step S506 and S508 in the EXAMPLE. It is basically the same as that in the base embodiment shown in FIG. 8. The difference is that the control program 540 obtains the present position information in the step S5717. The obtained present (contract) position information is used when calculating the insurance charge (step S5723). The reason for using each of the present (contract) position information is the same as that described in (1) New Contract of the EXAMPLE.

(4) Subscribed Contract Reference

The subscribed contract reference of the step S509 in the EXAMPLE is the same as the base embodiment shown in FIG. 9.

The operation of the insurance server 200 in the EXAMPLE is the same as that in the base embodiment shown in FIG. 10 and FIG. 11.

Effects of the THIRD EXAMPLE

With the EXAMPLE as described, effects as described hereinafter will be obtained.

Insurance companies can provide insurance commodities in which the condition of the insurance varies according to the position information at the time of contract. The reason is that the position information can be reflected in the insurance contract procedure such as at the time of calculating the insurance charge by the terminal.

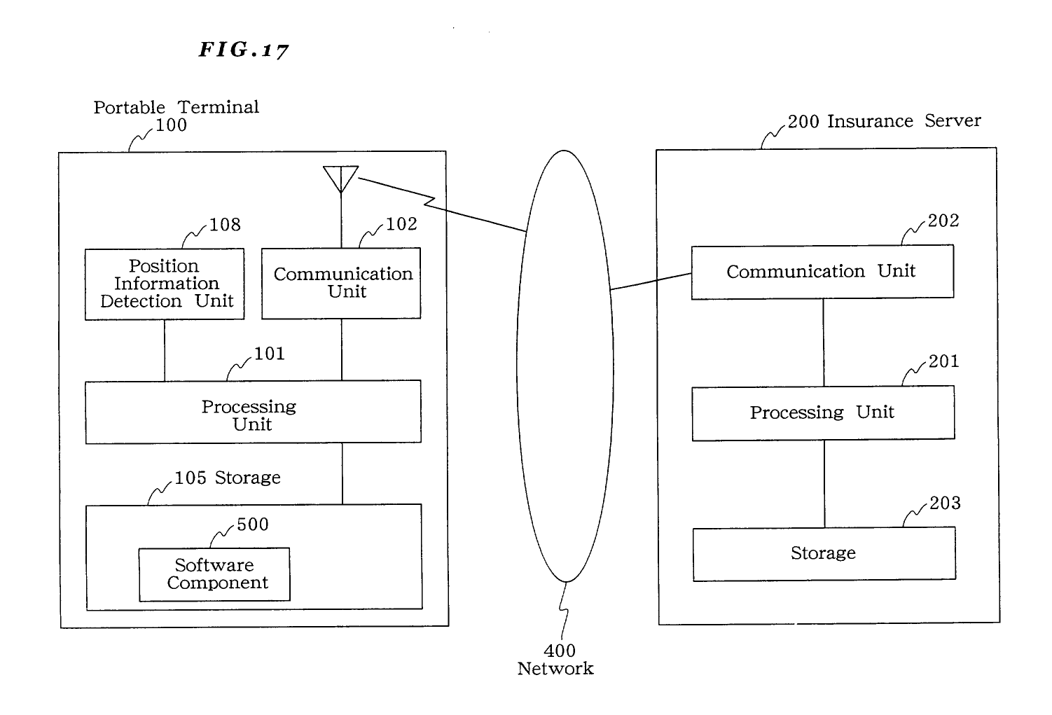

Next, a FOURTH EXAMPLE will be described. FIG. 17 is a simplified illustration of FIG. 1, which is simplified within a range sufficient to describe the FOURTH EXAMPLE. The FOURTH EXAMPLE as shown in FIG. 17 has a configuration in which a standard time generator 109 is added to the portable terminal 100 shown in FIG. 1.

The standard time generator 109 generates a punctual standard time so that users cannot adjust the time. Specifically, it maintains the punctuality by adjusting to the standard time transmitted from the transmission station of radio clock or a GPS satellite. Also, it may be installed to an IC (Integrated Circuit) substrate so that users cannot adjust the time at least from the application. However, it is not limited to this but various configuration may be applicable as long as it is the configuration in which users cannot adjust or alter the punctual time. Also, when the standard time information can be obtained from the communication unit 102 or the position information detection unit 108 of the FIRST to THIRD EXAMPLES, the communication unit 102 and the position information detection unit 108 may also serve as the standard time generator.

The basic configuration of the software component 500 for the user X in the FOURTH EXAMPLE is the same as that shown in FIG. 2. The difference is that, in the insurance policy data storage section 550, an item of contract time is set in the contract content 551 shown in FIG. 2 in addition to the policy numbers and the like 5511 to 5518.

The processing of generating the software component 500 is basically the same as that shown in FIG. 3. The differences are that the control program 540 can also control the standard time generator 109 and keeps the region of the insurance policy data storage section 550 so as to be able to store the contract time.

The agency server 300 installs the prepared software component to the portable terminal 100 by various methods. Also, it transmits the user ID 510, the user profile 520 and the base contract content to the insurance server 200.

Next, described is the operation in the case where the user performs the insurance contract by using the portable terminal 100 to which the software component 500 of the FOURTH EXAMPLE is installed. The selection processing of new contract, contract change, contract renewal and the subscribed contract reference by the user is the same as that in the embodiment as the base shown in FIG. 4 and FIG. 5.

(1) New Contract

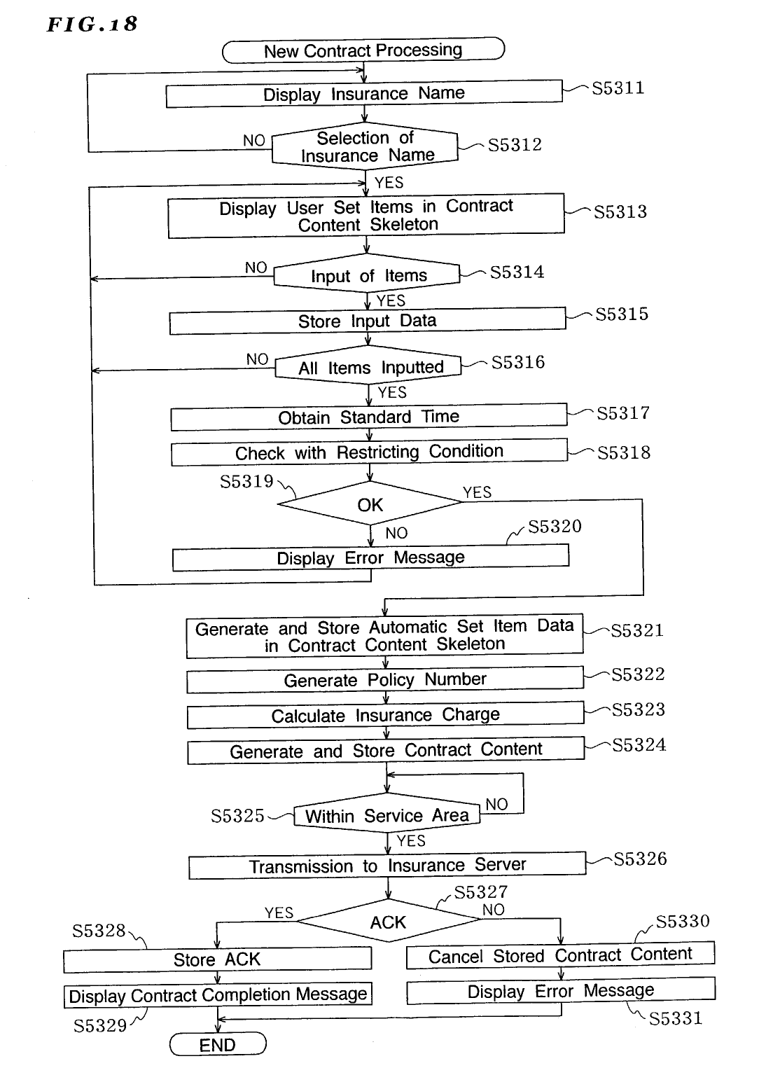

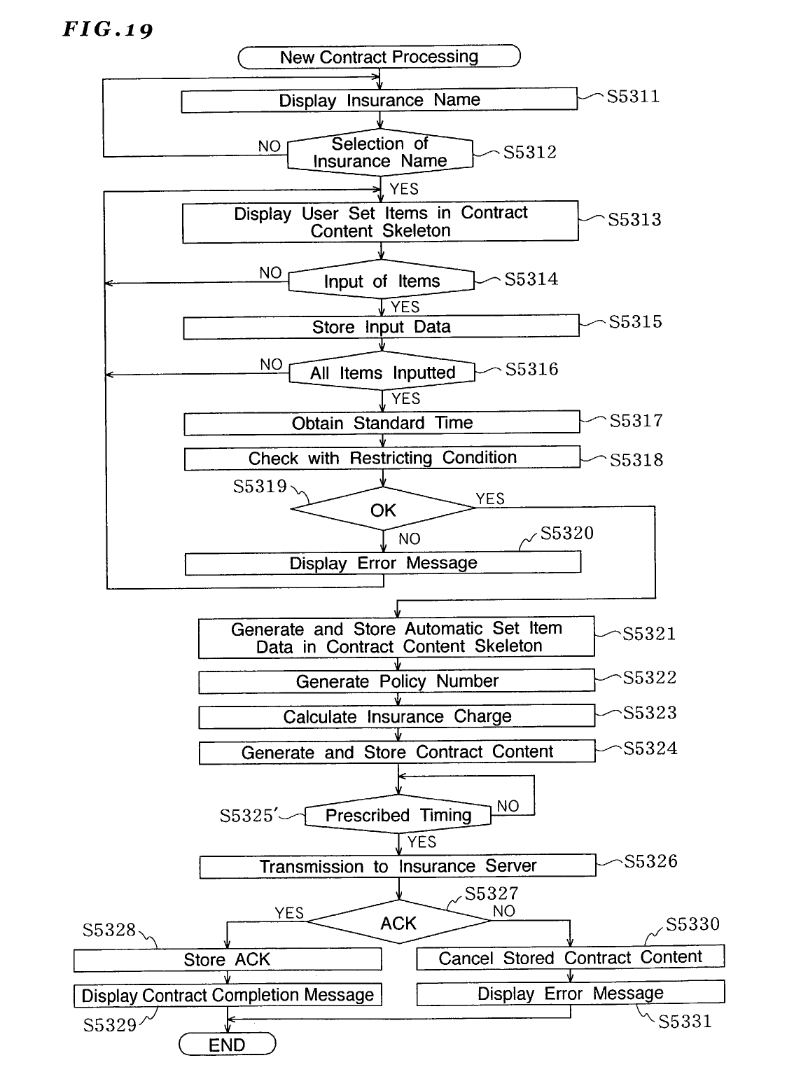

FIG. 18 and FIG. 19 show the detail of the new contract processing of the step S504 in the EXAMPLE. First, the control program 540 retrieves the insurance name/type of the insurance 5311 of all the insurance commodity recorded in the insurance commodity information 530 to display the list on the display unit 104 (step S5311) and waits for either one of the items to be selected (step S5312). When the user X selects the name of the insurance for new subscription from the displayed list of the insurance name through the input unit 103, the control program 540 displays the input screen of the user set items in the contract content skeleton 5312 for the selected insurance on the display unit 104 (step S5313), and waits for the user to input the value for each item (step S5314).

Then, the control program 540 monitors the input of data the input items on the input screen 621. When the user X inputs data through the input unit 103, the control program 540 temporarily stores the inputted data in the work region (step S5315).

Then, in the EXAMPLE, the control program 540 checks whether or not input has been completed to all the user set items (step S5316). If there is an uncompleted item, the control program 540 returns to the step S5313 and waits for the user X to input and if all the items are inputted, the control program 540 obtains the standard time including the date from the standard time generator 109 and temporarily stores it in the work region (step S5317).

Subsequently, the control program 540 checks with the restricting condition set in the insurance commodity information of the insurance (step S5318). For example, there is an upper limit on the premium as one of the restricting condition. If the premium inputted by the user X exceeds the upper limit designated by the restricting condition, it becomes a violation of the restricting condition (NO in the step S5319). In this case, the control program 540 displays a corresponding error message on the display unit 104 (step S5320), and returns to the step S5313 to let the user X perform re-input operation. In the step S5318, the check routine installed to the control program 540 performs a general check, e.g., whether or not the first day of the contract term is set to be a future data of the present date (the time and data generated by the standard time generator may be used) and whether or not the last day of the contract term is set to be the future date of the first day. When it is violated, the control program 540 displays a corresponding error massage (step S5320) and returns to the step S5313. In this respect, the EXAMPLE is capable of performing a check more precisely compared to the processing in the case without the standard time generator 109 being mounted on the terminal since punctuality is secured in the EXAMPLE.

When the inputted values of the user set items satisfy the restricting condition and pass the general check (YES in the step S5319), the control program 540 prepares the automatic set item data in the contract content skeleton 5312 for the selected insurance by referring to the user profile 520 and the standard time obtained in the step S5317, and temporarily stores the data in the work region (step S5321). In other words, name of the contractor, address and the like in the automatic set items are determined by referring to the user profile 520 and the contract date is determined according to the standard time.

Then, the control program 540 generates a policy number for the insurance for new contract at this time and temporarily stores it in the work region (step S5322). Subsequently, the control program 540 calculates the insurance charge required for the insurance contract according to the contract content of the insurance and the insurance charge calculation expression 5314 of the insurance information, and temporarily stores it in the work region (step S5323).

The control program 540 then completes the contract contents based on the contract content skeleton 5312 for the insurance, the values which are stored in the work region such as the user set items, the automatic set items, the policy number, the insurance charge and the contract time (standard time), and stores it in the front portion of the vacant region of the insurance policy data storage section 550 (step S5324).

In the EXAMPLE as shown in FIG. 18, the control program 540 starts the check whether the portable terminal 100 is in or out of the service area (step S5325). If it is within the service area (YES in the step S5325), the control program 540 starts the communication unit 102 to connect to the insurance server 200 through the network 400 and transmits to the insurance server 200 the new contract request data to which the contract content stored in the insurance policy data storage section 550 is attached (step S5326).

Through the processing, insurance contract can be concluded even if it is out of the service area of the portable terminal 100 since, in the EXAMPLE, the contract is concluded at the time when the use inputs the contract items to the portable terminal 100 but not at the time when the new contract request data is transmitted to the insurance server 200. This is made possible, as in the EXAMPLE, by maintaining the legitimacy of the time when the user inputs the contract items through mounting the standard time generator 109 on the terminal. In other words, the EXAMPLE does not work if it employs the time from a clock which can be adjusted by the user at will since it gives the user a chance to alter the contract date at will.

FIG. 19 shows an example of variations in which timing is counted without immediately transmitting the contract content to the insurance server 200 provided that the portable terminal 100 is within the service area. For example, it is possible to set the condition as follows: the timing of access can be set by monthly or every quarter of the year; the contract content is transmitted when it comes to be in the time with a relatively low communication charge; and the contract content is transmitted when there are three items to be reported (new contract, contract change and the like) to the insurance server 200.

In other words, in FIG. 19, when the contract content is stored in the insurance policy data storage section 550 (step S5324), the control program 540 checks whether or not it is the preset timing (step S5325′). When it becomes the prescribed timing (YES in the step 5325), the control program 540 starts the communication unit 102 to connect to the insurance server 200 through the network 400 and transmits to the insurance policy data storage section 550 the new contract request data to which the contract content stored in the insurance policy data storage section 550 is attached (step S5326).

Through the processing, users can save the communication charge. In this case also as in the case shown in FIG. 18, the contract is concluded at the time when the use inputs the contract items to the portable terminal 100 but not at the time when the new contract request data is transmitted to the insurance server 200. The reason is also the same as the case shown in FIG. 18.

Then, the control program 540 waits for the response from the insurance server 200. Upon receiving ACK showing that the new contract request data is normally received (YES in the step S5327), the control program 540 stores the ACK right after the contract content stored in the insurance policy data storage section 550 (step S5328) and displays a contract completion message on the display unit 104 (step S5329). Thereby, the processing shown in FIG. 18 and FIG. 19 is completed.

On the other hand, when NAK is returned from the insurance server 200 showing that the data is not received normally for unexpected reasons, the control program 540 cancels the contract content stored in the insurance policy data storage section 550 (step S5330), and displays an error massage on the display unit 104 showing that the contract is not completed due to difficulties in the insurance server 200 and the like (step S5331). Thereby, the processing showing FIG. 18 and FIG. 19 is completed. In the case of receiving the NAK, the processing of the step S5330 and the step S5331 may be executed only when the ACK is not returned even after repeating the transmission for a limited prescribed number of times. The contract content stored in the insurance policy data storage section 550 may not have to be canceled but remained with an invalid mark.

(2) Contract Change (3) Contract Renewal

The processing of the contract change and contract renewal in the step S506 and S508 in the EXAMPLE is basically the same as that in the base embodiment shown in FIG. 8. The difference is that the control program 540 obtains the standard time from the standard time generator 109 and waits the transmission of the contract content to the insurance server 200 until the prescribed timing. The processing in these respects is described in (1) New Contract of the EXAMPLE.

(4) Subscribed Contract Reference

The detail of the subscribed contract reference of the step S509 in the EXAMPLE is the same as the base embodiment shown in FIG. 9, since it is not especially necessary to store the date of subscribed contract reference. However, the date obtained from the standard time generator 109 may be added to the displayed record when displaying the contract content of the subscribed contract insurance in the step S553, in case if a third party reads the contract content without permission.

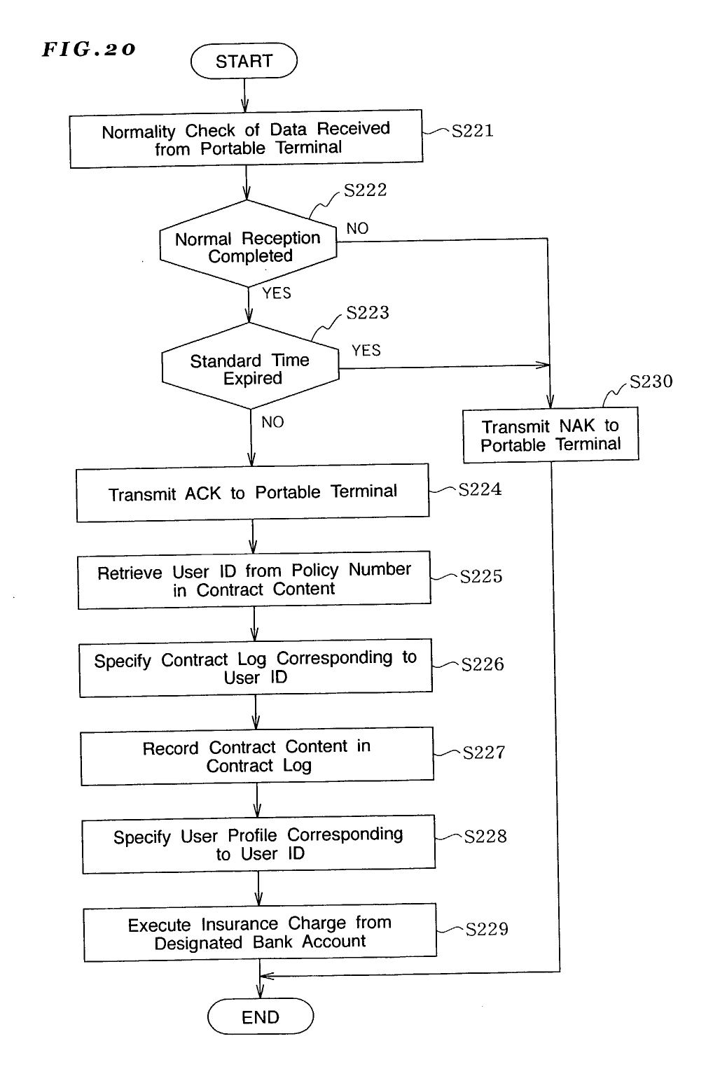

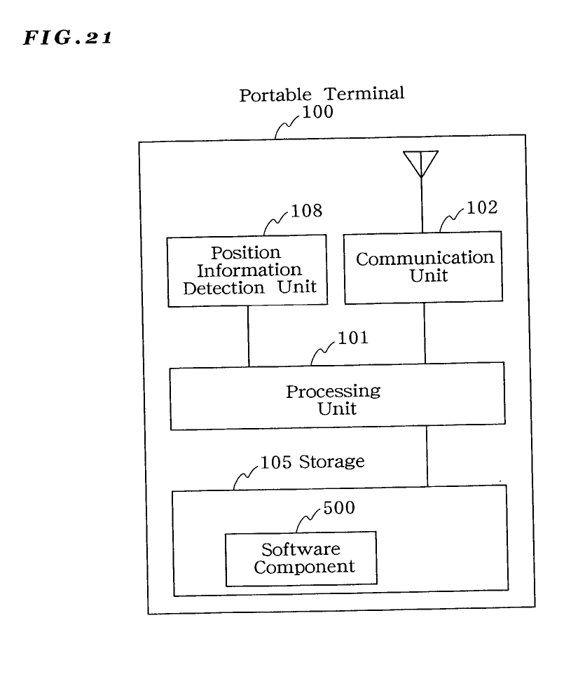

FIG. 20 shows the operation of the insurance server 200 in the EXAMPLE. FIG. 20 only shows reception of data from the portable terminal 100, since reception of data from the agency server 300 is the same as the processing shown in FIG. 10. The structural examples of the user management table 211, the user profile 221 and the contract log 231 provided in the storage 203 of the insurance server 200 are the same as those shown in FIG. 11. The difference is that the contract time obtained from the standard time generator 109 is contained in the contract content 232 of the contract log 231.

As shown in FIG. 20, upon receiving from the portable terminal 100 the new contract request data, the contract change request data, and the contract renewal request data, to which the contract content is attached, the insurance server 200 checks whether or not all the data is normally received using the error detection codes attached to the transmitted data (step S221). When all the data is not received normally (NO in the step S221), the insurance server 200 transmits the NAK showing that the data is not received normally to the portable terminal 100 which is the sender of the request (step S230). Thereby, the processing shown in FIG. 20 is completed.

When all the data is completely and normally received (YES in the step S221), the insurance server 200 makes the comparison of the present time to the contract time in the received data. If the difference is within a prescribed term (NO in the step S222), the insurance server 200 transmits NAK showing that the contract is not concluded due to expiration of the term to the portable terminal 100 which is the sender of the request (step S230). Thereby, the processing shown in FIG. 20 is completed.

The EXAMPLE is to fictitiously conclude (change, renew) insurance contract at the time of input of the contract items even if there is a time lag between the time (date) when the user inputs the contract items to the portable terminal 100 and the time (date) when the contract content based on the contract items is transmitted to the insurance server 200. However, it is inconvenient for insurance companies if the content of the insurance commodity provided at some point to be held for excessively long period of time. Thus, it is possible for insurance companies to set the limit to the date which can be retracted from the date of actual date reception. For example, provided that the term mentioned above is set to be 6 months, the contract inputted 7 months earlier to the portable terminal 100 can be processed as unconcluded.

In the step S223, when the contract time (date) is not expired (YES in the step 233), the insurance server 200 transmits a normal reception message (ACK) to the portable terminal 100 which is the sender of the request (step S224). Then, the user ID is retrieved from the first several figures of the policy number contained in the received content (step S225) and the user management table 211 is searched using the user ID to specify the contract log 231 appointed by the link address 215 of the entry 212 with the same user ID (step S226). The received contract content is recorded in the front portion of the vacant region of the contract log 231 (step S227). Needless to say, the contract time is also recorded.

Then, the user profile 211 appointed by the link address 214 of the retrieved entry 211 is specified (step S228) and the procedure is arranged for directly charging the insurance charge noted in the contract content at this time from the bank account data set in the user profile 221 (step S229). Thereby, the processing in FIG. 20 is completed. The insurance charge may be charged all together at a prescribed time such as in the end of the month instead of charging every time when receiving the new contract request data, contract change data, and contract renewal data from the portable terminal 100. Also, it may be charged not only from an account of a bank but also through credit companies or charged from a saving account of a stock company.

The EXAMPLE has been described heretofore, however, the invention is not limited to this but various kinds of modifications as described hereinafter are possible.

Timing of transmitting the contract data to the insurance server by a number of users is artificially shifted, thereby preventing the insurance server from receiving a number of data at once.

Effects of the FOURTH EXAMPLE

With the EXAMPLE as described, effects as described hereinafter can be obtained.

Users can subscribe for insurance whenever and wherever they need even in places where the radio wave of portable telephones cannot reach. The reason is that contract can be concluded at the time when the user inputs the contract items to the portable terminal but not at the time when the contract request data is transmitted, since the legitimacy of the date when the user inputs the contract items can be secured by mounting the standard time generator 109 on the terminal.

Users can save the communication charge. The reason is that the contract content can be transmitted not by every contract or change but by, to some extent, a mass unit. Also, it is possible to set for transmitting the contract content when reaching the time with a relatively low communication charge.

Insurance companies can decrease the cost such as investment in equipment and network maintenance in connection with an insurance server. The reason is that the contract content is not transmitted by every contract or change but by, to some extent. Also, timing of transmitting the data can be set on the insurance company side, thereby preventing the insurance server from receiving a number of data at once.

Next, a FIFTH EXAMPLE will be described. The EXAMPLE is completed by the portable terminal 100 itself without using the insurance server 200. FIG. 21 shows the portable terminal 100 of the FIFTH EXAMPLE. The portable terminal 100 of the EXAMPLE also comprises the same standard time generator 109 as that in the FOURTH EXAMPLE. The EXAMPLE employs a prepaid system. Thus, users are to obtain the prepaid balance by paying a prescribed amount of charge to agencies or insurance companies.

The basic structure of the software component 500 for the user X in the FIFTH EXAMPLE is basically the same as that shown in FIG. 2. The differences are: it has a configuration in which the prepaid balance is set in the user profile 520 and the control program 540 can do subtraction; a condition which is not to exceed the prepaid balance is added as one of the restricting condition of each insurance commodity information 531; and an item of the ACK 552 is not provided in the insurance policy data storage section 550.

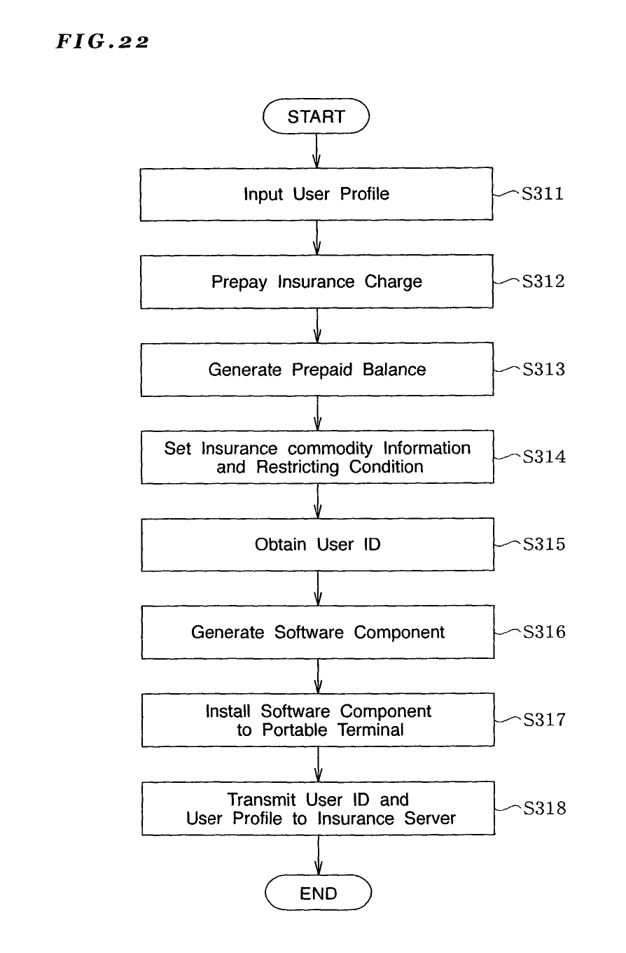

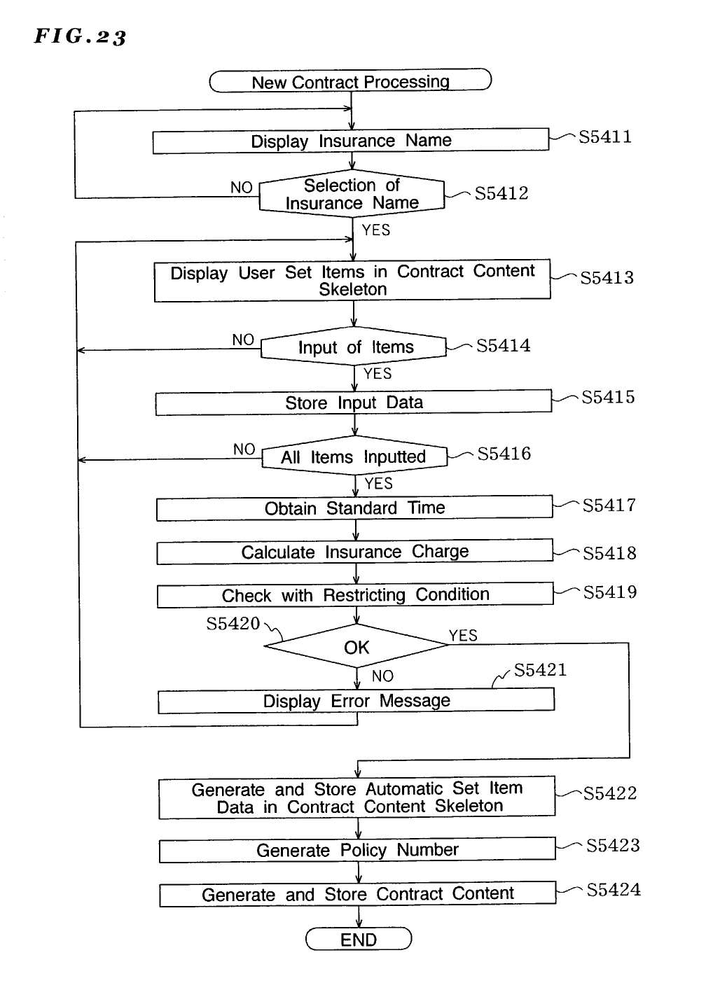

FIG. 22 shows an example of processing performed in the agency server 300 which generates the software component 500 of the FIFTH EXAMPLE. An operator Y of the insurance agency input through the input unit 303 the user profile of the user X such as address and the name based on the statement by the user X (step S311). The inputted user profile of the user X is temporarily stored in the storage 305. The user X prepays a prescribed amount of insurance charge at the time of reporting the above-mentioned items. The agency server 300 generates the prepaid balance according to the paid insurance charge (step S313). The generated prepaid balance is temporarily stored in the storage 305.

Subsequently, the operator Y determines by each insurance commodity stored in the insurance commodity information master 307 whether or not it is possible for the user X to subscribe for the commodity with the consideration of demand by the user, the user profile and the like. If it is determined to be applicable, the operator Y determines the restricting condition and prepares the insurance commodity information (insurance name/type of the insurance, the contract content skeleton, restricting condition, insurance charge calculation expression), which is specifically customized for the user X (step S314). At this point, if it is necessary to specify the subject to be insured such as in the case of automobile insurance, the model of the vehicles, license plate and the like are verified by the automobile inspection certificate to be set in the contract content skeleton in the commodity information of the automobile insurance. Also, in the case of the theft insurance, data for specifying the article to be insured is set in the contract content skeleton in the commodity information of the theft insurance. As described, the insurance commodity information and the restricting condition customized for the user X are temporarily stored in the storage 305. In the EXAMPLE, a restricting condition is also provided that the calculated insurance charge is to be within the prepaid balance.

Then, the operator Y starts the ID automatic numbering program which works on the processing unit 301 to generate the user ID with a prescribed figures (step S315). The generated user ID is temporarily stored in the storage 305. The generated ID may be a combination of any numbers and codes as long as it can discriminate the user from others.

Then, the operator Y starts the software automatic generating program which works on the processing unit 301 to prepare the software component (step S316). The software component automatic generating program combine the user ID, the user profile, and the insurance commodity information stored in the storage 305 and the control program stored in the control program storage 308 thereby generating the software component 500 as described in FIG. 2 and temporarily stores it in the storage 305. A sufficient region is provided in the insurance policy data storage section 550 of the software component 500.

The operator Y then connects the outer interface 306 of the agency server 300 and the outer interface 106 of the portable terminal 100 of the user X via connection cable and installs the software component 500 for the user X stored in the storage 305 of the agency server 300 to the storage 105 of the portable terminal 100 of the user X (step S317). At this time, the software component 500 may be stored in a card such as an IC card and hand it to the user X. Especially in the EXAMPLE, in order to let the user X prepay the charge, it is effective to employ a system which sells a corporeality such as a card.

Finally, the operator Y starts the transfer program which works on the processing unit 301 to transfer the data containing the user ID and the user profile stored in the storage 305 to the insurance server 200 through the network 400 (step S318). The processing may be omitted in the EXAMPLE. Also, the software component 500 may be generated in the insurance server 200.

Next, described is the operation in the case where the user performs the insurance contract by using the portable terminal 100 to which the software component 500 of the FIFTH EXAMPLE is installed. The selection processing of new contract, contract change, contract renewal, and the subscribed contract reference by the user is the same as that in the embodiment as the base shown in FIG. 4 and FIG. 5.

(b 1) New Contract

FIG. 23 shows the detail of the new contract processing of the step S504 in the FIFTH EXAMPLE. First, the control program 540 retrieves the insurance name/type of the insurance 5311 of all the insurance commodity recorded in the insurance commodity information 530 to display the list on the display unit 104 (step S5411), and waits for either one of the items to be selected (step S5412). When the user X selects the name of the insurance for new subscription from the displayed list of the insurance name through the input unit 103, the control program 540 displays the input screen of the user set items in the contract content skeleton 5312 for the selected insurance on the display unit 104 (step S5413), and waits for the user to input the value for each item (step S5414).

Then, the control program 540 monitors the input of data to the input items on the input screen 621. When the user X inputs data through the input unit 103, the control program 540 temporarily stores the inputted data in the work region (step S5415).

In the EXAMPLE, the control program 540 also checks whether or not input has been completed to all the user set items (step S5416). If there is an uncompleted item, the control program 540 returns to the step S5413 and waits for the user X to input and if all the items are inputted, the control program 540 obtains the standard time including the date from the standard time generator 109, and temporarily stores it in the work region (step S5417).

Subsequently, the control program 540 calculates the insurance charge required for the insurance contract according to the contract content of the insurance and the insurance charge calculation expression 5314 of the insurance commodity information 531, and temporarily stores it in the work region (step S5418).

Subsequently, the control program 540 checks with the restricting condition set in the insurance commodity information of the insurance (step S5419). In the EXAMPLE, it also checks whether or not the insurance charge calculated in the step S5418 can be covered by the prepaid balance. If there is a violation of the restricting condition (NO in the step S5420), the control program 540 displays a corresponding error message on the display unit 104 (step S5421) and returns to the step S5413 to let the user X perform re-input operation. If the prepaid balance is insufficient, the control program 540 let the user reselect the course with low charge.

In the step S5419, the check routine installed to the control program 540 performs a general check, e.g., whether or not the first day of the contract term is set to be a future data of the present date (the time and data generated by the standard time generator may be used) and whether or not the last day of the contract term is set to be the future date of the first day. When it is violated, the control program 540 displays a corresponding error massage (step S5421) and returns to the step S5413. In this respect, the EXAMPLE is capable of performing a check more precisely compared to the processing in the case without the standard time generator 109 being mounted to the terminal since punctuality is secured in the EXAMPLE.

When the inputted values of the user set items satisfy the restricting condition and pass the general check (YES in the step S5420), the control program 540 prepares the automatic set item data in the contract content skeleton 5312 for the selected insurance by referring to the user profile 520 and the standard time obtained in the step S5417, and temporarily stores the data in the work region (step S5422). In other words, name of the contractor, address and the like in the automatic set items are determined by referring to the user profile 520 and the contract date is determined according to the standard time.

Then, the control program 540 generates a policy number for the insurance for new contract at this time and temporarily stores it in the work region (step S5423). The control program 540 then completes the contract contents based on the contract content skeleton 5312 for the insurance, the values which are stored in the work region such as the user set items stored, the automatic set items, the policy number, the insurance charge, and the contract time (standard time), and stores it in the front portion of the vacant region of the insurance policy data storage section 550 (step S5424). Thereby, the processing shown in FIG. 23 is completed.

In the FIFTH EXAMPLE, unlike the FIRST to FOURTH EXAMPLES described above, there is no such processing that the contract content is transmitted to the insurance server 200 and receives ACK therefrom. Thus, conclusion of insurance contract becomes definite as the point when the contract content is stored in the insurance policy data storage section 550. Such method is also made possible in the EXAMPLE since, as in the case of the FOURTH EXAMPLE, the standard time obtained from the standard time generator 109 is set in the contract time so that users cannot adjust the contract time at will.

When there is a case to be insured such as a case of accident, by an operation of the user X, the contract content stored in the insurance policy data storage section 550 is transmitted to the insurance server 200, or the user X may bring in the portable terminal 100 directly to an office of the insurance company. The insurance company is to pay the premium to the user X in the case where the case to be insured takes place after the contract time. As described, through the processing of the EXAMPLE, a system can be provided in which the insurance server 200 is omitted. Users can also save the communication charge unless there is a case to be insured.

(2) Contract Change (3) Contract Renewal

The processing of the contract change and contract renewal of the step S506 and S508 in the EXAMPLE is basically the same as that in the base embodiment shown in FIG. 8. The difference are: the control program 540 obtains the standard time from the standard time generator 109; it makes a comparison of the prepaid balance to the calculated insurance charge; and no transmission of the changed contract content is performed to the insurance server 200. The processing in these respects is described in (1) New Contract of the EXAMPLE.

(4) Subscribed Contract Reference

The detail of the subscribed contract reference of the step S509 in the EXAMPLE is the same as the base embodiment shown in FIG. 9, since it is not especially necessary to store the date of subscribed contract reference. However, the date obtained from the standard time generator 109 may be added to the displayed record when displaying the contract content of the subscribed contract insurance in the step S553, in case if a third party reads the contract content without permission.

In the EXAMPLE, the insurance server 200 can be omitted so that there is no description of the operation of the insurance server 200 provided.

The EXAMPLE has been described, however, the invention is not limited to this but various modifications are possible.

The account may be settled by the communication between the control program and the insurance server to supplement the prepaid balance. The account maybe also settled through a home page on the Internet to supplement the prepaid balance through the Internet.

Transmission to the insurance server is changed to a necessary form at a point when there is no prepaid balance remained.

Effects of the FIFTH EXAMPLE

With the EXAMPLE as described, effects as described hereinafter can be obtained.

Users can subscribe for insurance whenever and wherever they need even in places where the radio wave of portable telephones cannot reach. The reason is that contract can be concluded at the time when the user inputs the contract items to the portable terminal but not at the time when the contract request data is transmitted, since the legitimacy of the date when the user inputs the contract items can be secured by mounting the standard time generator 109 on the terminal.

Users can save the communication charge. The reason is that there is no need to communicate with the insurance server at the time of contract and contract change.

Insurance companies can decrease the cost such as investment in equipment and network maintenance in connection with an insurance server. The reason is that there is no need to provide an insurance server for contract and contract change.

Next, a SIXTH EXAMPLE will be described. The EXAMPLE is applicable to any configuration in which communication between a portable terminal 100 and an insurance server 200 can be achieved.

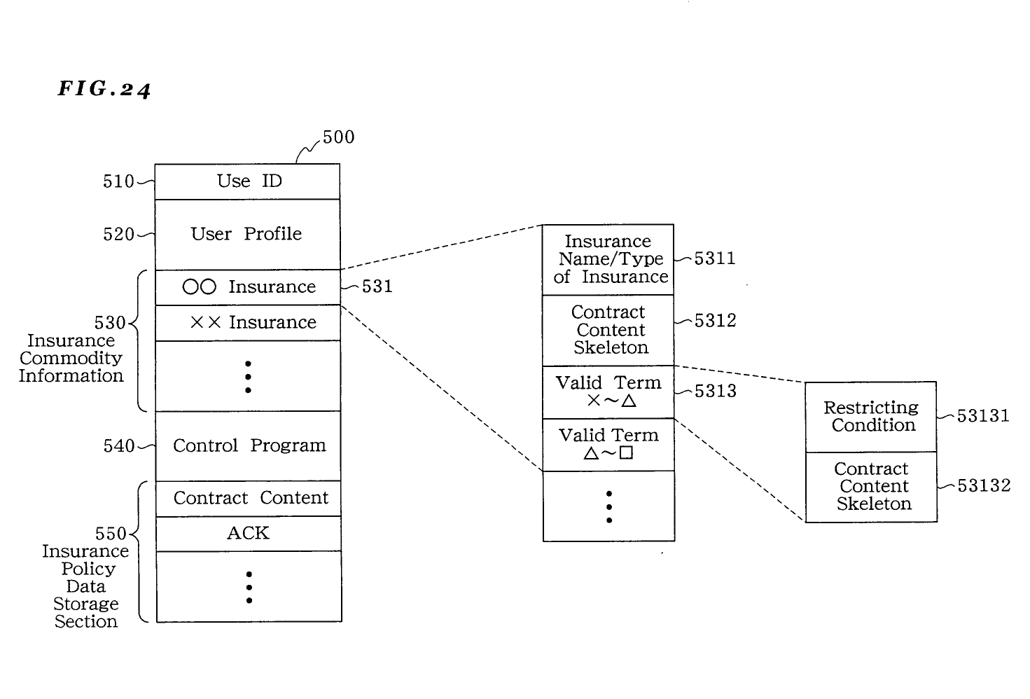

FIG. 24 shows the configuration of the software component 500 for the user X of the SIXTH EXAMPLE. The configuration shown in FIG. 24 is different from that shown in FIG. 2 in respect that an item of effective term 5313 is added to each insurance commodity information 531 contained in the insurance commodity information 530, and the restricting condition 53131 and the insurance charge calculation expression 53132 are set for each effective term. The effective term 5313 contains the term data including the first date/time to be effective and the last date/time to be expired for the restricting condition 53131 and the insurance charge calculation expression 53132 corresponding to the effective term 5313 as in “2001/11/27 0:00-2002/11/26 24:00”.

The processing of generating the software component 500 is the same as that shown in FIG. 3.

Next, described is the operation in the case where the user performs the insurance contract by using the portable terminal 100 to which the software component 500 of the SIXTH EXAMPLE is installed. The selection processing of new contract, contract change, contract renewal, and the subscribed contract reference by the user is the same as that in the embodiment as the base shown in FIG. 4 and FIG. 5.

(1) New Contract

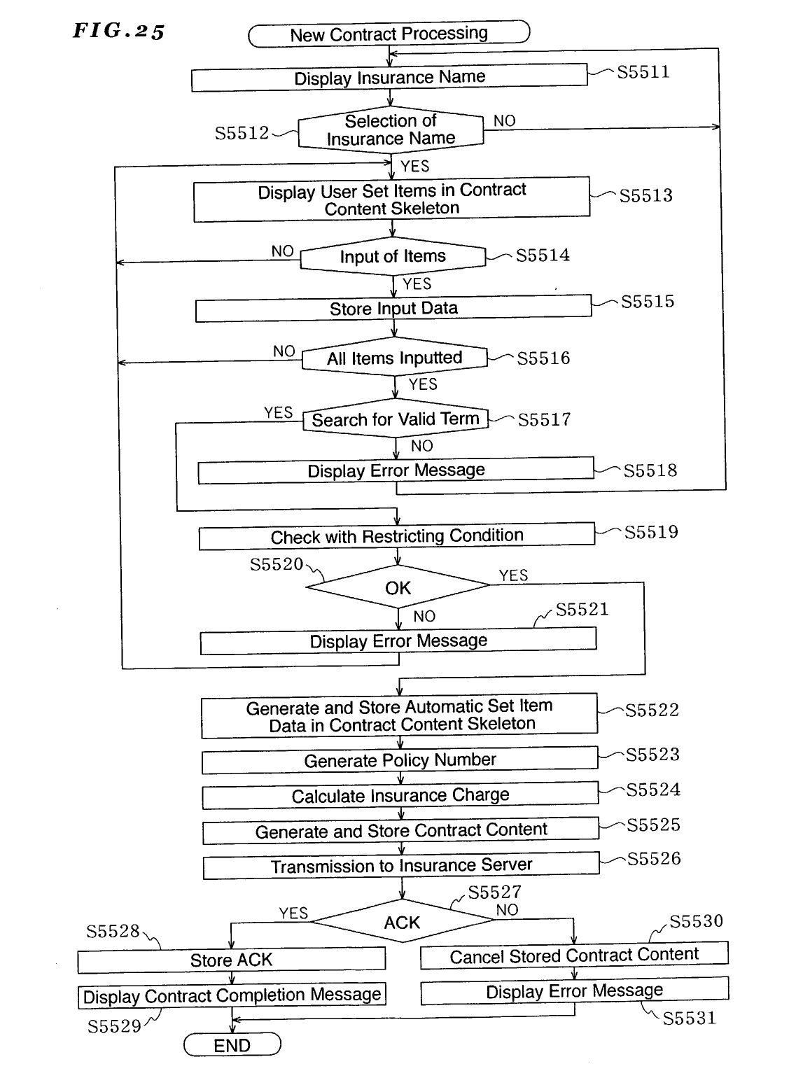

FIG. 25 shows the detail of the new contract processing of the step S504 in the SIXTH EXAMPLE. First, the control program 540 retrieves the insurance name/type of the insurance 5311 of all the insurance commodity recorded in the insurance commodity information 530 to display the list on the display unit 104 (step S5511) and waits for either one of the items to be selected (step S5512). When the user X selects the name of the insurance for new subscription from the displayed list of the insurance name through the input unit 103, the control program 540 displays the input screen of the user set items in the contract content skeleton 5312 for the selected insurance on the display unit 104 (step S5513), and waits for the user to input the value for each item (step S5514).

Then, the control program 540 monitors the input of data to the input items on the input screen 621. When the user X inputs data through the input unit 103, the control program 540 temporarily stores the inputted data in the work region (step S5515). The control program 540 also checks whether or not input has been completed to all the user set items (step S5516). If there is an uncompleted item, the control program 540 returns to the step S5513 and waits for the user X to input.

In the EXAMPLE, when all the items are completely inputted (YES in the step 5516), the control program 540 searches for insurance whose effective term covers the inputted contract start date in the effective term 5313 of the selected insurance commodity information 531 (step S5517). If there is no matched insurance (NO in the step S5517), the control program 540 displays a corresponding error message showing that there is no effective insurance (step S5518), and returns to the step S5511.

In the step S5517, when there is insurance matching the effective term 5313 (YES in the step 5517), the control program 540 checks with the restricting condition 53131 corresponding to the effective term 5313 (step S5519). For example, there is an upper limit on the premium as one of the restricting condition. If the premium inputted by the user X exceeds the upper limit designated by the restricting condition, it becomes a violation of the restricting condition (NO in the step S5520). In this case, the control program 540 displays a corresponding error message on the display unit 104 (step S5521,) and returns to the step S5513 to let the user X perform re-input operation.

When the inputted values of the user set items satisfy the restricting condition 53131 and pass the general check (YES in the step S5520), the control program 540 prepares the automatic set items data in the contract content skeleton 5312 for the selected insurance by referring to the user profile 520 and the present time, and temporarily stores the data in the work region (step S5522).

Then, the control program 540 generates a policy number for the insurance for new contract at this time and temporarily stores it in the work region (step S5523). Subsequently, the control program 540 calculates the insurance charge required for the insurance contract according to the contract content of the insurance and the insurance charge calculation expression 53132 corresponding to the effective term 5313 of the insurance commodity information 531, and temporarily stores it in the work region (step S5524).

The control program 540 then completes the contract contents based on the contract content skeleton 5312 for the insurance, the values which are stored in the work region such as the user set items, the automatic set items, the policy number, the insurance charge and the contract time position information, and stores it in the front portion of the vacant region of the insurance policy data storage section 550 (step S5525). The control program 540 then starts the communication unit 102 to be connected to the insurance server 200 through the network 400 and transmits to the insurance server 200 a new contract request data to which the contract content stored in the insurance policy data storage section 550 is attached (step S5526).

Then, the control program 540 waits for the response from the insurance server 200. Upon receiving ACK showing that the new contract request data is normally received (YES in the step S5527), the control program 540 stores the ACK right after the contract content stored in the insurance policy data storage section 550 (step S5528) and displays a contract completion message on the display unit 104 (step S5529). Thereby, the processing shown in FIG. 25 is completed.

On the other hand, when NAK is returned from the insurance server 200 showing that the data is not received normally for unexpected reasons, the control program 540 cancels the contract content stored in the insurance policy data storage section 550 (step S5530), and displays an error massage on the display unit 104 showing that the contract is not completed due to difficulties in the insurance server 200 and the like (step S5531). Thereby, the processing shown in FIG. 25 is completed. In the case of receiving the NAK, the processing of the step S5530 and the step S5531 may be executed only when the ACK is not returned even after repeating the transmission for a limited prescribed number of times. The contract content stored in the insurance policy data storage section 550 may not have to be canceled but remained with an invalid mark.

In FIG. 25, it is also possible to let the users input the contract start date before the step S5511 to exclusively display the insurance commodity information 531 with the information within the effective term for making selection.

(2) Contract Change (3) Contract Renewal

The processing of the contract change and contract renewal in the step S506 and S508 in the EXAMPLE is basically the same as that in the base embodiment shown in FIG. 8. The difference is that the control program 540 searches for the effective term 5313 based on the contract start date from the selected insurance commodity information. The processing in this respect is described in (1) New Contract of the EXAMPLE.

(4) Subscribed Contract Reference

The detail of the subscribed contract reference of the step S509 in the EXAMPLE is the same as the base embodiment shown in FIG. 9.

The operation of the insurance server 200 in the contract procedure for the EXAMPLE is also the same as that in the base embodiment shown in FIG. 10.

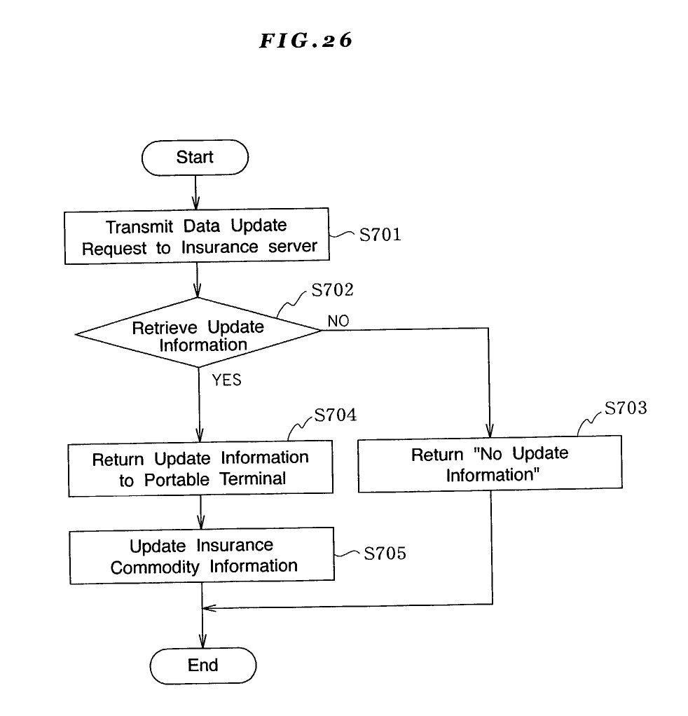

In the SIXTH EXAMPLE, processing for rewriting data unit (insurance commodity information 530) of the software component 500 on the portable terminal side, which wile be described later, is performed between the portable terminal 100 and the insurance server 200. FIG. 26 shows the processing. The software component 500 of the portable terminal 100 transmits the user ID 510 and the data update request to the insurance server 200 at a regular timing such as once a day (step S701).

The insurance server 200 retrieves the new insurance commodity information 530 (insurance name 5311, effective term 5313, contract content skeleton 5312, restricting condition 53131, and insurance charge calculation expression 53132), which is corresponding to the received user ID and to be updated (step S702). When there is no new insurance commodity information to be updated (NO in the step S702), the insurance server 200 returns a message to the software component 500 showing that there is no information to be updated (step S703). The software component 500 completes the processing without taking any step when receiving the massage showing there is no information to be updated.

When there is new insurance commodity information to be updated (YES in the step S702), the insurance server 200 returns the data (step S704). The software component 500, upon receiving the new insurance commodity information to be updated, updates the returned insurance name 5311, contract content skeleton 5312, effective term 5313, restricting condition 53131, and insurance charge calculation expression 53132 in the corresponded data of the insurance commodity information 531 in the insurance commodity information 530, thereby completing the processing (step S705). The software component 500 completes the processing without taking any step when receiving the massage showing there is no information to be updated.

In addition to the case of once-a-day timing, it is also possible to perform the same processing in other timing, e.g., when NAK is returned at the time of subscribing for insurance, when the expiration data is approaching, and when reporting an accident. Also, after the processing, a step may be added in which the software component 500 cancels the insurance commodity information with expired effective term 5313.

The EXAMPLE is effective when it is necessary to change the insurance commodity information (content of insurance, restricting condition, insurance charge calculation expression) for which users can subscribe due to change in ranks and the like because of accidents, introduction of new commodities and the like. In the EXAMPLES described earlier, it is necessary to replace the portable terminal 100 together with the software component 500 in order to perform the change. To achieve this, it is necessary to go through the same step as that at the time of subscribing for insurance.

Also, the EXAMPLE is effective when limiting the subscription for insurance from the software component 500 of the terminal due to expiration of the contract, circumstantial condition of insurance companies, replacement of the software component 500 with an improved model, and the like. In the EXAMPLES described earlier, it is necessary to go through a process such as canceling the software component 500 of the portable terminal 100 itself in order to perform the change so that it is difficult to achieve automatic control by the insurance server 200.

Effects of the SIXTH EXAMPLE

With the EXAMPLE as described, effects as described hereinafter can be obtained.

It is easy to change the insurance commodity information. The reason is that it can be automatically updated at a specific timing such as once a day.

Also, insurance companies can control the validity and invalidity of insurance for a user. The reason is that the terminal software component can be controlled through transmitting the expiration data of the insurance from the insurance server.

Next, a SEVENTH EXAMPLE will be described. The EXAMPLE is applicable to any configuration in which communication between a portable terminal 100 and an insurance server 200 can be achieved.

The basic structure of the software component 500 for the user X in the SEVENTH EXAMPLE is basically the same as that shown in FIG. 2.

The processing of generating the software component 500 is the same as that shown in FIG. 3.

The agency server 300 installs the prepared software component to the portable terminal 100 by various methods. Also, it transmits the user ID 510, the user profile 520 and the base contract content to the insurance server 200.

Described is the operation in the case where the user performs the insurance contract by using the portable terminal 100 to which the software component 500 of the SEVENTH EXAMPLE is installed. The selection processing of new contract, contract change, contract renewal, and the subscribed contract reference by the user is the same as that in the embodiment as the base shown in FIG. 4 and FIG. 5.

Also, each processing of new contract, contract change, and the subscribed contract reference is the same as that shown in FIG. 6, FIG. 8, and FIG. 9, respectively.

The configuration of the insurance server 200 of the EXAMPLE is the same as that shown in FIG. 11. The difference is that an item of a forwarding address is provided in the user profile 221.

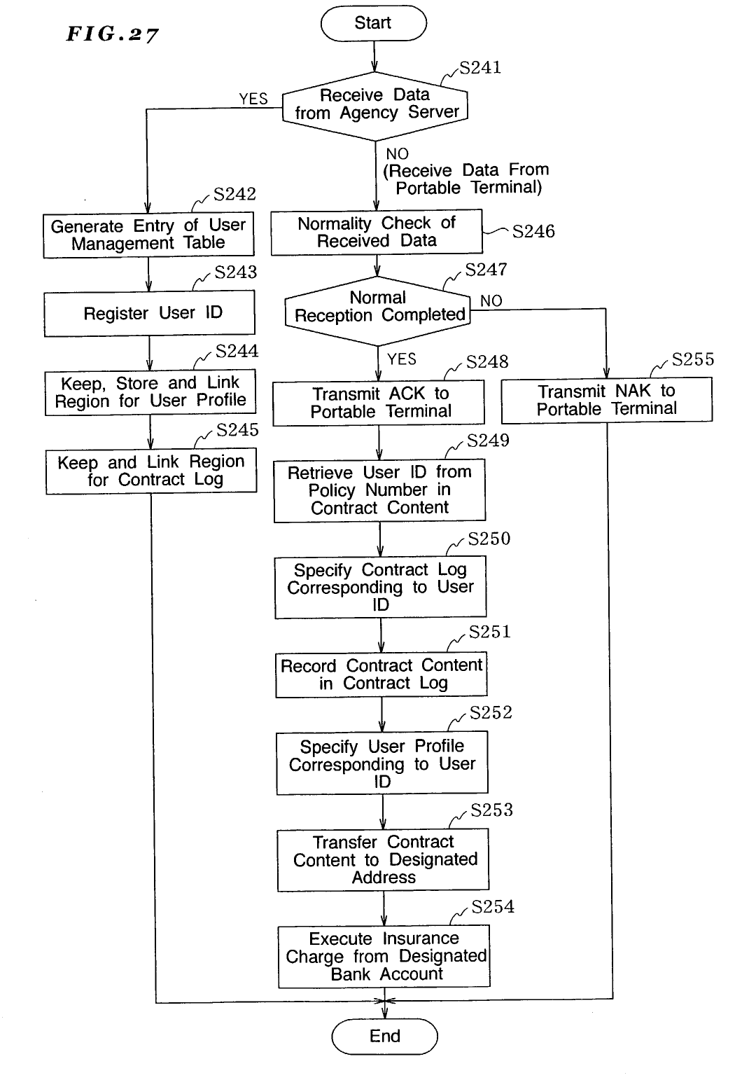

Next, the operation of the insurance server 200 will be described by referring to FIG. 27. Upon receiving the user ID and user profile from the agency server 300 (YES in the step S241), the insurance server 200 generates one entry 212 in the user management table 211 (step S242) and registers the received user ID to the portion for the user ID 213 (step S243). Then, the insurance server 200 keeps the region for the user profile 221 and stores the received user profile while setting the front address of the user profile 221 in the portion of the link address 214 of the generated entry 212 in the user management table 211 (step S244). Finally, the insurance server 200 keeps the region for the contract log 231 and set the front address of the region in the portion of the link address 215 of the generated entry 212 in the user management table 221 (step S245).

On the other hand, upon receiving, from the portable terminal 100, the new contract request data to which the contract content is attached, the contract change request data, and the contract renewal request data from the portable terminal 100 (NO in the step S241), the insurance server 200 checks by the error detection codes attached to the transmitted data whether or not all the data is normally received (step S246). When all the data is not received normally (NO in the step S247), the insurance server 200 transmits the NAK showing that the data is not received normally to the portable terminal 100 which is the sender of the request (step S244). Thereby, the processing shown in FIG. 27 is completed.

When all the data is completely and normally received (YES in the step S207), a normal reception message (ACK) showing that the data is normally received is transmitted to the portable terminal 100 which is the sender of the request (step S248). Then, the user ID is retrieved from the first several figures of the policy number contained in the received content (step S249) and the user management table 211 is searched using the user ID to specify the contract log 231 appointed by the link address 215 of the entry 212 with the same user ID (step S250). The received contract content is recorded in the front portion of the vacant region of the contract log 231 (step S251).

Then, the user profile 221 appointed by the link address 214 of the retrieved entry 211 is specified (step S252) and transmits the contract content according to the forwarding address set in the user profile 221 (step S253). Specifically, by forwarding a copy of the contract content to a FAX at home of the user X, to the e-mail address and the like, it enables to save the insurance data in case if the portable terminal is damaged. Finally, the procedure is arranged for directly charging the insurance charge noted in the contract content at this time from the bank account data set in the user profile 221 (step S254). Thereby, the processing in FIG. 27 is completed. The insurance charge may be charged all together at a prescribed time such as in the end of the month instead of charging every time when receiving the new contract request data, contract change data, and contract renewal data from the portable terminal 100.

The EXAMPLE has been described heretofore, however, the invention is not limited to this but various kinds of modifications as described hereinafter are possible.

By setting the forwarding address to be a third party institution for all the users, insurance contract content is to be in custody of the institution. Also, inspection by the third party institution contributes to increasing the credibility of the insurance system.

The forwarding address is set to be the address of the user. In this case, an insurance policy is printed by the insurance server and mailed to the residence of the user.

Effects of the SEVENTH EXAMPLE

With the EXAMPLE as described, effects as described hereinafter can be obtained.

The sense of security for users can be improved when using the system. The reason is that it enables to save the insurance data in case when the portable terminal is damaged by forwarding a copy of the contract content to a FAX at home of the user X, to the e-mail address and the like.

Insurance companies can leave the credibility of the system management to a third party institution. The reason is that, by setting the forwarding address to be a third party institution for all the users, insurance contract content is to be in custody of the institution. Thus, inspection by the third party institution contributes to increasing the credibility of the insurance system.

The EXAMPLES of the invention have been described heretofore, however, the invention is not limited to the EXAMPLES but various kinds of modifications as described hereinafter are possible.

A method of installing software component to the storage of the portable terminal 100 is employed for installing the software component 500 in the portable terminal 100. However, the software component 500 may be stored in card medium such as a PC card and JAVA card, and loaded to the card slot of the portable terminal for installation.

The insurance server 200 is also prepared to be useable as the agency server 300 by providing the insurance server 200 with the same function as that of the agency server 300.

The agency server 300 is composed of a portable personal computer to be carried by an insurance sales person.

The software component 500 generated by the agency server 300 and stored in the storage 305 is downloaded and installed to the portable terminal 100 through the network 400 such as the Internet.

Through a homepage on the Internet provided by an insurance company or insurance agency, a user by himself or herself performs input of own user profile and selection of the insurance commodity to subscribe for. Also, through the homepage, the user automatically obtains the user ID, generates the software component, and downloads and installs the software component to the portable terminal 100 of the user through the Internet.

If the user X has already subscribed for several insurance at the time of generating the software component 500 for the user X, the software component 500 to which a pair of contract content 551 and ACK 552 of the subscribed insurance is stored in the insurance policy data storage section 550 is generated and installed to the portable terminal 100.

If the user X wishes to subscribe for several insurance at the time of generating the software component 500 for the user X, the software component 500 in which a pair of contract content 551 and ACK 552 of the insurance to be subscribed is stored in the insurance policy data storage section 550 is generated and installed to the portable terminal 100. Thereby, it becomes unnecessary to take the trouble to go through the new subscription procedure using the portable terminal 100.

At the time of generating the software component 500 for the user X, the software component 500, in which a pair of insurance content and ACK 552 is stored in the insurance policy data storage section 550 assuming that insurance contracts with the premium of 0 yen are concluded for all or a part of the recorded insurance commodity information 530, is generated and installed to the portable terminal 100. In this case, the contract actually becomes effective as insurance at a point when the premium is increased by changing the contract for the insurance contract with the premium of 0 yen.

The insurance charge can be settled using a prepaid card. In this case, the portable terminal comprises: a reader/writer for prepaid cards; a system for verifying that the balance of the prepaid card is sufficient to pay the insurance charge for this contract (new contract, contract change or contract renewal) at least before transmitting the contract content to the insurance server; if the balance is not sufficient, a system for displaying a message by interrupting the processing thereafter in the case of insufficient balance; and if the balance is sufficient, a system for subtracting the insurance charge for this contract from the prepaid card provided that there is a normal reception message (ACK) transmitted from the insurance server. In the configuration in which the software component 500 is stored in a card medium and installed to the portable terminal as described, the card medium can be also used as a prepaid card.

With the present invention as described, for example, effects as described hereinafter can be obtained.

Users can surely and easily manage the subscribed insurance through the portable terminal. The reason is that the contract content of the subscribed insurance is stored in the portable terminal itself. Thus, it becomes possible to check the contract content of the subscribed insurance whenever and wherever it is necessary by simply carrying the portable terminal.

Users can perform renewal of the subscribed insurance and change of the contract content through the portable terminal. The reason is that the contract content of the subscribed insurance is stored in the portable terminal itself and the renewal of the insurance and contract change are completed through communicating with the insurance server only once.

It is possible to perform a control according to insurance menu prepared suitable for individual user. The reason is that a software component containing insurance commodity information prepared specifically for individual user is to be installed to the portable terminal. Also, it is made highly convenient for the users since the users are provided with the insurance menu provided suitable for themselves.

It is possible that the portable terminal serve as an insurance policy. The reason is that the contract content transmitted to the insurance server and a normal reception message (ACK) showing that the insurance server normally received the contract content are recorded in the insurance policy data storage section of the portable terminal. Also, the contract content is generated by a software component which is a function originated from the insurance company. Therefore, it can be considered as the same insurance policy as that printed on a paper medium.

The effects distinctive to each EXAMPLE are noted at the end of each EXAMPLE.

The invention may be embodied in other specific forms without departing from the spirit or essential characteristic thereof. The present embodiments are therefore to be considered in all respects as illustrative and not restrictive, the scope of the invention being indicated by the appended Claims rather than by the foregoing description and all changes which come within the meaning and range of equivalency of the Claims are therefore intended to be embraced therein.

The entire disclosure of Japanese Patent Application No. 2001-282840 (Filed on Sep. 18, 2001) and 2001-373351 (Filed on Dec. 6, 2001) including specification, claims, and summary are incorporated herein by reference in its entirety.

What is claimed is:

1. An insurance contract method comprising the steps of:
transmitting, from a portable terminal to an insurance server through a network, a contract content of insurance for a new contract, contract change or contract renewal, whose policy number is set on the potable terminal side;
storing a normal reception message transmitted from the insurance server and the transmitted contract content in a memory of the portable terminal by corresponding them to one another.

2. An insurance contract method comprising the steps of:
installing, to a portable terminal, a software component containing a user profile, insurance commodity information, a control program for controlling a procedure for insurance contract based on the insurance commodity information, and an insurance policy data storage section;
by the control of the control program, generating the contract content of insurance for a new contract, contract change, or contract renewal based on information about an insurance commodity selected by a user, data inputted by the user, the user profile, the policy number generated by the control program and the content of the insurance policy data storage section, and transmitting it to an insurance server through a network; and
storing a normal reception message transmitted from the insurance server and the transmitted contract content to the insurance policy data storage section by corresponding them to one another.

3. The insurance contract method as claimed in claim 2, wherein: the insurance commodity information contains information about at least one insurance commodity prepared suitable for individual user and also restricting condition which must be satisfied at the time of preparing the contract content for the individual user so as to check the content with the restricting condition at the time of preparing the contract content.

4. An insurance contract method comprising the steps of:
installing, to a portable terminal, a software component containing a user profile, insurance commodity information, a control program for controlling a procedure for insurance contract based on the insurance commodity information, and an insurance policy data storage section;
by the control of the control program, inputting user set items for an insurance commodity selected by a user;
obtaining a present position information of the portable terminal;
comparing the present position information obtained by the present position information obtaining step to base position information contained in the restricting condition of the insurance commodity information;
generating contract content of insurance by the control program for a new contract, contract change or contract renewal only when the information match in the comparing step;
transmitting the contract content generated by the contract generating step to an insurance server through a network; and
storing a normal reception message transmitted from the insurance server and the contract content transmitted in the transmitting step to the insurance policy data storage section by corresponding them to one another.

5. An insurance contract method comprising the steps of:
installing, to a portable terminal, a software component containing a user profile, insurance commodity information, a control program for controlling a procedure for insurance contract based on the insurance commodity information, and an insurance policy data storage section;
by the control of the control program, inputting user set items for an insurance commodity selected by a user;
obtaining a present position information of the portable terminal;
generating contract content of insurance by the control program for a new contract, contract change or contract renewal containing the present position information obtained in the present position obtaining step;
transmitting the contract content generated by the contract generating step to an insurance server through a network; and
storing a normal reception message transmitted from the insurance server and the contract content transmitted in the transmitting step to the insurance policy data storage section by corresponding them to one another.

6. The insurance contract method as claimed in claim 5, further comprising the step of adjusting contract content by area for applying area parameter to the contract content by the insurance server based on position information at the time of contract, that is, the present position information obtained in the present position obtaining step contained in the contract contents transmitted to the insurance server in the transmitting step.

7. An insurance contract method comprising the steps of:
installing, to a portable terminal, a software component containing a user profile, insurance commodity information, a control program for controlling a procedure for insurance contract based on the insurance commodity information, and an insurance policy data storage section;
by the control of the control program, inputting user set items for an insurance commodity selected by a user;
obtaining a present position information of the portable terminal;
generating areal contract content of insurance by the control program for a new contract, contract change or contract renewal with the present position information obtained in the present position information obtaining step as area parameter;
transmitting the areal contract content generated by the areal contract generating step to an insurance server through a network; and
storing a normal reception message transmitted from the insurance server and the transmitted contract contents in the transmitting step to the insurance policy data storage section by corresponding them to one another.

8. An insurance contract method comprising the steps of:
installing, to a portable terminal, a software component containing a user profile, insurance commodity information, a control program for controlling a procedure for insurance contract based on the insurance commodity information, and an insurance policy data storage section;
by the control of the control program, inputting user set items for an insurance commodity selected by a user;
obtaining the standard time at the time of inputting user set items in the setting item input step;
generating contract content of insurance by the control program for a new contract, contract change or contract renewal containing the contract time information, that is, the standard time obtained in the standard time obtaining step;
transmitting the contract content generated by the contract generating step to an insurance server through a network; and
storing a normal reception message transmitted from the insurance server and the transmitted contract contents in the transmitting step to the insurance policy data storage section by corresponding them to one another.

9. The insurance contract method as claimed in claim 9, wherein the transmitting step is for transmitting the contract contents generated in the contract generating step to the insurance server at a prescribed timing.

10. An insurance contract method comprising the steps of:
installing, to a portable terminal, a software component containing a user profile, insurance commodity information, a control program for controlling a procedure for insurance contract based on the insurance commodity information and prepaid balance, and an insurance policy data storage section;
by the control of the control program, inputting user set items for an insurance commodity selected by a user;
obtaining the standard time at the time of inputting user set items in the setting item input step;
checking whether or not the charge of the insurance commodity selected by the user is within the prepaid balance; and
generating contract content of insurance by the control program for a new contract, contract change or contract renewal containing the contract time information, that is, the standard time obtained in the standard time obtaining step only when the charge is verified to be within the prepaid balance in the checking step.

11. The insurance contract method as claimed in claim 1, further comprising the update step for updating the insurance commodity information by the control program through making an inquiry to the insurance server through the network.

12. The insurance contract method as claimed in claim 1, further comprising the transfer step performed by the insurance server for transferring the contract content of the insurance for the new contract, contract change or the contract renewal to the designated forwarding address.

13. An insurance contract system comprising an insurance server and a portable terminal capable of communicating with the insurance server through a network, wherein
the portable terminal comprises:
a unit for transmitting the contract content of insurance for a new contract, contract change or contract renewal whose policy number is generated on the portable terminal side to the insurance server through the network;
a unit for storing a normal reception message transmitted from the insurance server and the transmitted contract content to a memory of the portable terminal by corresponding them to one another; and
a unit for displaying the content stored in the memory; wherein
the insurance server comprises:
a unit for returning the normal reception message when the contract content is normally received from the portable terminal; and
a unit for recording the normally-received contract contents.

14. An insurance contract system comprising an insurance server and a portable terminal capable of communicating with the insurance server through a network, wherein
the portable terminal comprises:
a software component containing a user profile, insurance commodity information, a control program for controlling a procedure for insurance contract based on the insurance commodity information, and an insurance policy data storage section; wherein
the control program generates contract content of insurance for a new contract, contract change, or contract renewal based on the insurance commodity information selected by a user, data inputted by the user, the user profile, the policy number generated by the control program, and the content of the insurance policy data storage section, and transmits it to an insurance server through a network while storing a normal reception message transmitted from the insurance server and the transmitted contract content to the insurance policy data storage section by corresponding them to one another; and
the insurance server comprises:
a unit for returning the normal reception message when the contract content is normally received from the portable terminal; and
a unit for recording the normally-received contract contents.

15. The insurance contract system as claimed in claim 14, wherein:
the insurance commodity information contains information about at least one insurance commodity generated suitable for the individual user and also restricting condition which must be satisfied at the time of preparing the contract content for the individual user; and
the control program checks with the restricting condition at the time of preparing the contract content.

16. The insurance contract system as claimed in claim 13, wherein:
the portable terminal further comprises a present position detection unit for detecting present position of the portable terminal; and
the control program compares the present position information detected by the present position information detection unit and a base position information contained in the restriction condition of the insurance commodity information, and generates the contract content only when the position information match.

17. The insurance contract system as claimed in claim 13, wherein:
the portable terminal further comprises a present position information detection unit for detecting present position of the portable terminal; and
the insurance server applies area parameter to the contract content based on position information at the time of contract, that is, the present position information detected by the present position information detection unit contained in the contract content transmitted from the portable terminal.

18. The insurance contract system as claimed in claim 13, wherein the portable terminal further comprises a present position information detection unit for detecting the present position information of the portable terminal; and
the control program generates areal contract content of the insurance with the present position information detected by the present position information detection unit as area parameter.

19. The insurance contract system as claimed in claim 13, wherein the portable terminal further comprises a standard time generating unit for generating standard time; and
the control program generates the contract content containing contract time information, that is, the standard time generated by the standard time generating unit.

20. The insurance contract system as claimed in claim 19, wherein the control program transmits the contract content to an insurance server at a prescribed timing.

21. The insurance contract system as claimed in claim 13, wherein the control program updates the insurance commodity information by making an inquiry to the insurance server through the network.

22. The insurance contract system as claimed in claim 13, wherein the insurance server transfers the contract content of the insurance for the new contract, contract change or the contract renewal to the designated forwarding address.

23. A portable terminal capable of communicating with an insurance server through a network, comprising:
a unit for transmitting the contract content of insurance for a new contract, contract change or contract renewal, whose policy number is generated on the portable terminal side to the insurance server through the network;
a unit for storing a normal reception message transmitted from the insurance server and the transmitted contract content to a memory of the portable terminal by corresponding them to one another; and
a unit for displaying the content stored in the memory on a display unit.

24. A portable terminal capable of communicating with an insurance server through a network, comprising:
a software component containing a user profile, insurance commodity information, a control program for controlling a procedure for insurance contract based on the insurance commodity information, and an insurance policy data storage section; wherein the control program generates contract content of insurance for a new contract, contract change, or contract renewal based on the insurance commodity information selected by a user, data inputted by the user, the user profile, the policy number generated by the control program, and the content of the insurance policy data storage section, and transmits it to an insurance server through a network while storing a normal reception message transmitted from the insurance server and the transmitted contract content to the insurance policy data storage section by corresponding them to one another.

25. The portable terminal as claimed in claim 24, wherein the insurance commodity information contains information about at least one insurance commodity generated suitable for individual user and also restricting condition which must be satisfied at the time of preparing the contract content for the individual user; and
the control program checks with the restricting condition at the time of preparing the contract content.

26. The portable terminal as claimed in claim 23, further comprising a present position information detection unit for detecting present position information of the portable terminal; wherein the control program compares the present position information detected by the present position information detection unit and a base position information contained in restricting condition of the insurance commodity information, and generates the contract content only when the position information match.

27. The portable terminal as claimed in claim 23, further comprising a present position information detection unit for detecting present position information of the portable terminal; wherein the control program generates areal contract content of the insurance with the present position information detected by the present position information detection unit as area parameter.

28. The portable terminal as claimed in claim 23, further comprising a standard time generating unit for generating standard time, wherein the control program generates the contract content containing contract time information, that is, the standard time generated by the standard time generating unit.

29. The portable terminal as claimed in claim28, wherein the control program transmits the contract content to an insurance server at a prescribed timing.

30. A portable terminal comprising:
a software component containing a user profile, insurance information commodity, a control program for controlling a procedure for insurance contract based on the insurance commodity information and prepaid balance, and an insurance policy data storage section; and a standard time generating unit for generating standard time; wherein
the control program checks whether or not the charge of the insurance commodity selected by the user is within the prepaid balance, and generates contract content of insurance for a new contract, contract change or contract renewal containing the contract time information, that is, the standard time generated by the standard time generating unit only when the charge is verified to be within the prepaid balance.

31. The portable terminal as claimed in claim 23, wherein the control program updates the insurance commodity information by making an inquiry to the insurance server through the network.

32. An insurance contract computer program product stored in storage medium for operating a computer to execute the processing of:
transmitting, from a computer forming a portable terminal capable of communicating with an insurance server through a network to the insurance server through the network, the contract content of insurance for a new contract, contract change or contract renewal whose policy number is generated on the portable terminal side from a computer forming a portable terminal capable of communicating with an insurance server through a network to the insurance server through the network;
storing a normal reception message transmitted from the insurance server and the transmitted contract content to a memory of the portable terminal by corresponding them to one another; and
displaying the content stored in the memory on a display unit.

33. An insurance contract computer program product installed to a portable terminal capable of communicating with an insurance server through a network for controlling a user profile, insurance commodity information and insurance contract procedure based on the insurance commodity information, wherein the program operates a computer to execute the processing of:
generating the contract content of insurance for a new contract, contract change, or contract renewal based on insurance commodity information selected by a user, data inputted by the user, the user profile, the policy number generated by the control program and the content of the insurance policy data storage section, and transmitting it to an insurance server through a network;
storing a normal reception message transmitted from the insurance server and the transmitted contract content to the insurance policy data storage section by corresponding them to one another; and
displaying the contract content stored in the insurance policy data storage section on a display unit.

34. The insurance contract computer program product as claimed in claim 33, wherein
the insurance commodity information contains information about at least one insurance commodity generated suitable for individual user and also restricting condition which must be satisfied at the time of preparing the contract content for the individual user; and the control program checks with the restricting condition at the time of preparing the contract content.

35. An insurance contract computer program product installed to a portable terminal capable of communicating with an insurance server through a network for controlling a user profile, insurance commodity information and insurance contract procedure based on the insurance commodity information, wherein the program operates a computer to execute:
a set item input processing for inputting user set items for an insurance commodity selected by a user;
a present position information obtaining processing for obtaining a present position information of the portable terminal;
a comparing processing for comparing the present position information obtained by the present position information obtaining step to base position information contained in the restricting condition of the insurance commodity information;
a contract generating processing for generating contract content of insurance for a new contract, contract change or contract renewal only when the information match in the comparing processing;
a transmitting processing for transmitting the contract contents generated by the contract generating step to an insurance server through a network; and
a storing processing for storing a normal reception message transmitted from the insurance server and the contract content transmitted by the transmitting processing to the insurance policy data storage section by corresponding them to one another.

36. An insurance contract computer program product installed to a portable terminal capable of communicating with an insurance server through a network for controlling a user profile, insurance commodity information and insurance contract procedure based on the insurance commodity information, wherein the program operates a computer to execute:
a set item input processing for inputting user set items for an insurance commodity selected by a user;
a present position information obtaining processing for obtaining a present position information of the portable terminal;
a contract generating processing for generating contract content of insurance for a new contract, contract change or contract renewal containing a present position information obtained by the present position information obtaining processing;
a transmitting processing for transmitting the contract content generated by the contract generating step to an insurance server through a network; and
a storing processing for storing a normal reception message transmitted from the insurance server and the contract content transmitted by the transmitting processing to the insurance policy data storage section by corresponding them to one another.

37. An insurance contract computer program product installed to a portable terminal capable of communicating with an insurance server through a network for controlling a user profile, insurance commodity information and insurance contract procedure based on the insurance commodity information, wherein the program operates a computer to execute:
a set item input processing for inputting user set items for insurance commodities selected by a user;
a present position information obtaining processing for obtaining a present position information of the portable terminal;
an areal contract generating processing for generating areal contract content of insurance by the control program for a new contract, contract change or contract renewal with the present position information obtained in the present position information obtaining step as area parameter;
a transmitting processing for transmitting the areal contract contents generated by the areal contract generating step to an insurance server through the network; and
a storing processing for storing a normal reception message transmitted from the insurance server and the contract content transmitted in the transmitting step to the insurance policy data storage section by corresponding them to one another.

38. An insurance contract computer program product installed to a portable terminal capable of communicating with an insurance server through a network for controlling a user profile, insurance commodity information and insurance contract procedure based on the insurance commodity information, wherein the program operates a computer to execute:
a set item input processing for inputting user set items for an insurance commodity selected by a user;
a standard time obtaining processing for obtaining the standard time at the time of inputting user set items by the set item input processing;
a contract generating processing for generating contract content of insurance for a new contract, contract change or contract renewal containing the contract time information, that is, the standard time obtained by the standard time obtaining processing;
a transmitting processing for transmitting the contract contents generated by the contract generating processing to an insurance server through the network; and
a storing processing for storing a normal reception message transmitted from the insurance server and the contract content transmitted by the transmitting processing to the insurance policy data storage section by corresponding them to one another.

39. The insurance contract computer program product as claimed in claim 38, wherein the transmitting processing transmits the contract content generated by the contract generating processing to an insurance server at a prescribed timing.

40. An insurance contract computer program product installed to a portable terminal capable of communicating with an insurance server through a network for controlling a user profile, insurance commodity information and insurance contract procedure based on the insurance commodity information and prepaid balance, wherein the program operates a computer to execute:
a set item input processing for inputting user set items for an insurance commodity selected by a user;
a standard time obtaining processing for obtaining the standard time at the time of inputting user set items in the setting item input step;
a checking processing for checking whether or not the charge of the insurance commodity selected by the user is within the prepaid balance; and
a contract generating processing for generating contract content of insurance for a new contract, contract change or contract renewal containing the contract time information, that is, the standard time obtained in the standard time obtaining processing only when the charge is verified to be within the prepaid balance by the checking processing.

41. The insurance contract computer program product as claimed in claim 32, wherein the program further operates the computer to execute an update processing for updating the insurance commodity information by making an inquiry to the insurance server through the network.
